(19) United States
(12) Patent Application Publication
(10) Pub. No.: US 2014/0074521 A1
(43) Pub. Date: Mar. 13, 2014

(54) ADMISSION SYSTEM

(71) Applicant: USJ Co. Ltd., Osaka (JP)

(72) Inventors: Tsuyoshi Morioka, Osaka (JP); Keisuke Kitaguchi, Osaka (JP); Toyotsugu Shiba, Osaka (JP)

(73) Assignee: USJ CO., LTD., Osaka (JP)

(21) Appl. No.: 14/009,381

(22) PCT Filed: Aug. 9, 2013
(86) PCT No.: PCT/JP2013/004808

§ 371 Date: Oct. 2, 2013

(30) Foreign Application Priority Data
Sep. 12, 2012 (JP) 2012-200894

(51) Int. Cl. G06Q 10/02

(52) U.S. Cl. CPC G06Q 10/02
USPC 705/5

(57) ABSTRACT

To construct an admission system that raises a limit to the number of sales of tickets such as annual passport relative to an upper limit of on-site guests so as to reduce guests frustrated by inability to buy the tickets and that achieves a high degree of guest satisfaction. An annual passport 20 as a ticket is available as one that permits admission on odd-numbered days and one that permits admission on even-numbered days. Judging means for admission 16 of a server 4 fetches from a recording part 12 ticket information 14 corresponding to a ticket ID transmitted from a control device for entrance gate 2, and determines which of “the odd-numbered day” and “the even-numbered day” is the admission day of the pertinent annual passport 20. Further, the judging means for admission 16 determines whether today is the odd-numbered day or the even-numbered day and whether or not today matches admission day information of the pertinent annual passport 20. If it matches, the judging means determines to permit admission. If not, the judging means determines not to permit admission.

### TECHNICAL FIELD

The present invention relates to an admission system that uses tickets for entrance to facilities such as theme parks.

### BACKGROUND ART

In facilities such as a theme park, the number of guests admitted therein is limited by factors which include the number of guests per unit time who can access an attraction or show, the seating capacity of a restaurant or the like, the number of crew members (on-site operators) and the like. If guests in excess of the upper limit are admitted, there may cause problems with the attraction, show and restaurant or with the response of the crew members, which may lead to fear of decreased guest satisfaction.

As a solution to such a problem, Patent Document 1 (Japanese Laid-open Patent Application 2003-303361 (JP-A-2003-303361)) discloses a system which takes the following procedure to limit the entrance of the guests so as to keep the number of on-site guests within the upper limit. Sensors are provided at entrance and exit gates of the facilities to count the present number of on-site guests. Out of the sold tickets for the day, the number of yet-unused tickets is determined. If the sum of the present number of on-site guests and the number of yet-unused tickets exceeds the upper limit of on-site guests, further sale of tickets is suspended. By taking this procedure, the entrance of guests in excess of the upper limit is prevented and thus, the decrease in on-site guest satisfaction is prevented.

### SUMMARY OF THE INVENTION

### 1. Problem to be Solved by the Invention

The conventional system as disclosed in Patent Document 1 is effective in facilities where tickets only on the day are sold or where tickets designating one admission day are sold in advance. However, the conventional system is not effective in facilities where tickets, such as an annual passport, that permit repeated entrance in a predetermined period are sold. This is because all the guests having such tickets do not visit the facilities on all the days in the predetermined period and hence, the number of on-site guests cannot be determined based on the number of yet-unused tickets.

Because of such reasons, the number of sales of tickets, such as annual passports, that permit repeated entrance into the facilities for the predetermined period is limited in conjunction with the upper limit of the on-site guests. This also leads to frustration of guests who are unable to purchase the annual passport.

Further, the system as disclosed in Patent Document 1 also involves fear of frustration of a guest who is unable to gain the admission because whether the ticket is available or not is not known until the guest actually visits the facilities.

In view of this, the invention has an object to construct an admission system that raises the limit to the number of sales of annual passports relative to the upper limit of on-site guests so as to reduce the guests frustrated by inability to purchase the tickets and that achieves a high degree of guest satisfaction by previously providing the guests with basic information on whether or not the admission is permitted.

### 2. Means for Solving the Problem

(1) (2) An admission system according to the invention is an admission system which corresponds to a ticket permitting admission to facilities on either an odd-numbered day or an even-numbered day within a predetermined period, and includes a control device for entrance gate disposed at an entrance to the facilities and a server communicably connected to the control device for entrance gate, in which

the server includes: a recording part that records ticket information which includes a ticket ID of the ticket and admission day information indicating whether the pertinent ticket permits admission on the odd-numbered day or the even-numbered day; judging means for admission that obtains the admission day information of the pertinent ticket based on the ticket ID transmitted from the control device for entrance gate and determines whether or not at least today is the day when the pertinent ticket permits admission; and transmitting means that transmits a judgment result of the judging means for admission to the control device for entrance gate via a transmission part, and

in which the control device for entrance gate includes: obtaining means for ticket ID that obtains a ticket ID from a ticket possessed by a user; transmitting means that transmits the obtained ticket ID to the server via the transmission part; and control means that outputs “admitted/unadmitted” to a display part based on a judgment result of the judging means for admission transmitted from the server.

Therefore, the system can increase the number of sales of the annual passports relative to the upper limit of on-site guests. Whether or not the admission is permitted can be easily confirmed at the entrance gate.

(3) (4) An admission system according to the invention is an admission system which further includes a ticket sales device connected to the server, in which the ticket sales device includes transmitting means that transmits application for saving admission to the server, in which judging means for saving admission possibility of the server receives the application for saving admission transmitted from the ticket sales device and judges the possibility of saving admission, in which the server further includes decision means for saving admission that receives the application for saving admission and updates the ticket information recorded in the recording part with an information piece “saving admission permitted” if the judging means for saving admission possibility determines that the saving admission is possible, and in which the judging means for admission of the server refers to the ticket information of the recording part and determines to permit admission if at least today is the day when the pertinent ticket permits admission or if “saving admission permitted” applies to the pertinent ticket.

Therefore, the system can provide the possibility of saving admission to a guest who has mistakenly visited the facilities. Further, the application for saving admission can be made at the ticket sales device.

(5) (6) (7) An admission system according to the invention is an admission system which corresponds to a ticket permitting admission to facilities on either an odd-numbered day or an even-numbered day within a predetermined period, and includes a control device for entrance gate disposed at an entrance to the facilities and a server communicably connected to the control device for entrance gate, in which

the server includes: a recording part that records ticket information which includes a ticket ID of the ticket and admission day information indicating whether the pertinent ticket permits admission on the odd-numbered day or on the even-numbered day and records prediction information of on-site guests; judging means for admission that obtains the admission day information of the pertinent ticket based on the ticket ID transmitted from the control device for entrance gate and determines whether or not at least today is the day when the pertinent ticket permits admission; judging means for saving admission possibility that, when the judging means for admission determines not to permit admission, determines, based on the prediction information of on-site guests recorded in the recording part, whether or not a predicted number of on-site guests for today leaves room relative to the upper limit of the on-site guests and determines that the saving admission is possible if there is some room or determines that the saving admission is impossible if there is little room; and transmitting means that transmits judgment results of the judging means for admission and judging means for saving admission possibility to the control device for entrance gate via a transmission part, and

in which the control device for entrance gate includes: obtaining means for ticket ID that obtains a ticket ID from a ticket possessed by a user; transmitting means that transmits the obtained ticket ID to the server; and control means that outputs “admitted/unadmitted” to a display part based on a judgment result of the judging means for admission transmitted from the server, and that in the case of “unadmitted”, outputs “saving admission possible/impossible” to the display part based on a judgment result of the judging means for saving admission possibility.

Therefore, the system can provide the possibility of saving admission to a guest who mistakenly intends to enter the facilities.

(8) An admission system according to the invention is an admission system in which the prediction information of on-site guests recorded in the recording part is data on the number of on-site guests predicted at predetermined time intervals, and in which the judging means for saving admission possibility of the server includes: calculating means for actual on-site guests that calculates the present number of actual on-site guests based on the number of guests admitted by the judging means for admission and the number of exited guests detected by an exiting guest sensor; correcting means for prediction information that corrects the prediction information of on-site guests based on the present number of actual on-site guests and the predicted number of on-site guests at a predetermined clock time corresponding to the present clock time; and judging means for overflow that determines whether or not the corrected prediction of on-site guests will exceed the upper limit of on-site guests at any clock time from now, and determines that the saving admission is impossible if the upper limit will be exceeded or determines that the saving admission is possible if the upper limit will not be exceeded.

Therefore, the system can correct the predicted number of on-site guests based on the difference between the predicted number of on-site guests and the number of actual on-site guests so as to properly determine whether or not the saving admission is possible.

(9) An admission system according to the invention is an admission system in which the judging means for saving admission possibility receives inquiry about the possibility of saving admission from the ticket sales device and judges the possibility of saving admission, and in which the transmitting means transmits a judgment result of the judging means for saving admission possibility in response to the inquiry about the possibility of saving admission transmitted from the ticket sales device.

Therefore, the possibility of saving admission can be confirmed at the ticket sales device.

(10) An admission system according to the invention is an admission system in which the judging means for saving admission possibility receives application for saving admission transmitted from the ticket sales device and judges the possibility of saving admission, in which the server further includes decision means for saving admission that receives the application for saving admission and updates the ticket information recorded in the recording part with an information piece “saving admission permitted” if the judging means for saving admission possibility determines that the saving admission is possible, and in which the judging means for admission refers to the ticket information of the recording part and determines to permit admission if at least today is the day when the pertinent ticket permits admission or if “saving admission permitted” applies to the pertinent ticket.

Therefore, the saving admission can also be handled at the entrance gate similarly to the normal admission.

(11) An admission system according to the invention is an admission system in which the judging means for saving admission possibility updates the ticket information recorded in the recording part with an information piece “saving admission possible” when the judging means for admission determines not to permit admission and the judging means for saving admission possibility determines that the saving admission is possible, in which the server further includes decision means for saving admission that receives application for the saving admission and updates the ticket information with an information piece “saving admission permitted” if the ticket information indicates that the saving admission is possible, and in which the judging means for admission refers to the ticket information of the recording part and determines to permit admission if at least today is the day when the pertinent ticket permits admission or if “saving admission permitted” applies to the pertinent ticket.

Therefore, a guest whose saving admission is determined to be possible at the entrance gate is preferentially admitted.

(12) An admission system according to the invention is an admission system which corresponds to a ticket permitting admission to facilities on a given day within a predetermined period, and a control device for entrance gate disposed at an entrance to the facilities and a server communicably connected to the control device for entrance gate, in which

the server includes: a recording part that records ticket information which includes a ticket ID of the ticket and admission day information indicating a day when the pertinent ticket permits admission;

judging means for admission that obtains the admission day information of the pertinent ticket based on the ticket ID transmitted from the control device for entrance gate and determines whether or not at least today is the day when the pertinent ticket permits admission; and transmitting means that transmits a judgment result of the judging means for admission to the control device for entrance gate via a transmission part, and

in which the control device for entrance gate includes: obtaining means for ticket ID that obtains a ticket ID from a ticket possessed by a user; transmitting means that transmits the obtained ticket ID to the server via the transmission part; and control means that outputs “admitted/unadmitted” to a display part based on a judgment result of the judging means for admission transmitted from the server.

Therefore, the system can increase the number of sales of the annual passports relative to the upper limit of on-site guests. Whether or not the admission is permitted can be easily confirmed at the entrance gate.

(13) An admission system according to the invention is an admission system which corresponds to a ticket permitting admission to facilities on a given day within a predetermined period, and includes a control device for entrance gate disposed at an entrance to the facilities and a server communicably connected to the control device for entrance gate, in which

the server includes: a recording part that records ticket information which includes a ticket ID of the ticket and admission day information indicating a day when the pertinent ticket permits admission and records prediction information of on-site guests; judging means for admission that obtains the admission day information of the pertinent ticket based on the ticket ID transmitted from the control device for entrance gate and determines whether or not at least today is the day when the pertinent ticket permits admission; judging means for saving admission possibility that, when the judging means for admission determines not to permit admission, determines, based on the prediction information of on-site guests recorded in the recording part, whether or not a predicted number of on-site guests for today leaves room relative to an upper limit of the on-site guests and determines that the saving admission is possible if there is some room or determines that the saving admission is impossible if there is little room; and transmitting means that transmits judgment results of the judging means for admission and the judging means for saving admission possibility to the control device for entrance gate via a transmission part, and

in which the control device for entrance gate includes: obtaining means for ticket ID that obtains a ticket ID from a ticket possessed by a user; transmitting means that transmits the obtained ticket ID to the server via the transmission part; and control means that outputs “admitted/unadmitted” to a display part based on a judgment result of the judging means for admission transmitted from the server and that in the case of “admission unpermitted”, outputs “saving admission possible/impossible” to the display part based on a judgment result of the judging means for saving admission possibility.

Therefore, the system can provide the possibility of saving admission to a guest who has mistakenly visited the facilities. Further, the application for saving admission can be made at the ticket sales device.

(14) (15)An admission system according to the invention is an admission system which corresponds to a ticket permitting admission to facilities on either an odd-numbered day or an even-numbered day within a predetermined period, and includes a control device for entrance gate disposed at an entrance to the facilities and a server communicably connected to the control device for entrance gate, in which

the server includes: a recording part that records ticket information which includes a ticket ID of the ticket and admission day information indicating whether the pertinent ticket permits admission on the odd-numbered day or on the even-numbered day; obtaining means for ticket information that obtains ticket information corresponding to the pertinent ticket ID transmitted from the control device for entrance gate; and transmitting means that transmits the ticket information to the control device for entrance gate via a transmission part, and

in which the control device for entrance gate includes: obtaining means for ticket ID that obtains a ticket ID from a ticket possessed by a user; transmitting means that transmits the obtained ticket ID to the server via the transmission part; judging means for admission that obtains the admission day information of the pertinent ticket based on the ticket information transmitted from the server and determines whether or not at least today is the day when the pertinent ticket permits admission; and control means that outputs “admitted/unadmitted” to a display part based on a judgment result of the judging means for admission.

Therefore, the system can increase the number of sales of the annual passports relative to the upper limit of on-site guests. Whether or not the admission is permitted can be easily confirmed at the entrance gate.

(16) (17) An admission system according to the invention is an admission system which further includes a ticket sales device connected to the server, in which the ticket sales device includes transmitting means that transmits decision on saving admission to the server, in which the server further includes decision means for saving admission that receives the decision on saving admission and updates the ticket information recorded in the recording part with an information piece “saving admission permitted”, and in which the judging means for admission of the control device for entrance gate refers to the ticket information and determines to permit admission if at least today is the day when the pertinent ticket permits admission or if “saving admission permitted” applies to the pertinent ticket.

Therefore, the system can provide the possibility of saving admission to a guest who has mistakenly visited the facilities. Further, the application for saving admission can be made at the ticket sales device.

(18) (19) An admission system according to the invention is an admission system which corresponds to a ticket permitting admission to facilities on either an odd-numbered day or an even-numbered day within a predetermined period, and includes a control device for entrance gate disposed at an entrance to the facilities and a server communicably connected to the control device for entrance gate, in which

the server includes: a recording part that records ticket information which includes a ticket ID of the ticket and admission day information indicating whether the pertinent ticket permits admission on the odd-numbered day or on the even-numbered day and records prediction information of on-site guests; obtaining means for ticket information that obtains ticket information corresponding to the pertinent ticket ID transmitted from the control device for entrance gate; obtaining means for fundamental information that receives request for fundamental information transmitted from the control device for entrance gate and obtains fundamental information including at least prediction information of on-site guests; and transmitting means that transmits the ticket information and the fundamental information to the control device for entrance gate via a transmission part, and

in which the control device for entrance gate includes: obtaining means for ticket ID that obtains a ticket ID from a ticket possessed by a user; transmitting means that transmits the obtained ticket ID to the server via the transmission part; judging means for admission that obtains the admission day information of the pertinent ticket based on the ticket information transmitted from the server, determines whether or not at least today is the day when the pertinent ticket permits admission, and transmits to the server request for fundamental information used for judgment of the possibility of saving admission when determining not to permit admission; judging means for saving admission possibility that determines, based on the fundamental information transmitted from the server, whether or not a predicted number of on-site guests for today leaves room relative to an upper limit of the on-site guests and determines that the saving admission is possible if there is some room or determines that the saving admission is impossible if there is little room; and control means that outputs “admitted/unadmitted” to a display part based on a judgment result of the judging means for admission, and that in the case of “admission unpermitted”, outputs “saving admission possible/impossible” to the display part based on a judgment result of the judging means for saving admission possibility.

Therefore, the system can provide the possibility of saving admission to a guest who mistakenly intends to enter the facilities.

(20) An admission system according to the invention is an admission system in which the prediction information of on-site guests recorded in the recording part is data on the number of on-site guests predicted at predetermined time intervals, in which the server includes: calculating means for actual on-site guests that calculates the present number of actual on-site guests based on the number of guests admitted by the judging means for admission and the number of exited guests detected by an exiting guest sensor and records the present number of actual on-site guests in the recording part; and correcting means for prediction information that corrects the prediction information of on-site guests based on the present number of actual on-site guests and the predicted number of on-site guests at a predetermined clock time corresponding to the present clock time and records the corrected prediction information in the recording part, and in which the judging means for saving admission possibility of the control device for entrance gate includes judging means for overflow that determines whether or not the predicted number of on-site guests will exceed the upper limit of on-site guests at any clock time from now, and determines that the saving admission is impossible if the upper limit will be exceeded or determines that the saving admission is possible if the upper limit will not be exceeded.

Therefore, the system can correct the predicted number of on-site guests based on the difference between the predicted number of on-site guests and the number of actual on-site guests so as to properly determine whether or not the saving admission is possible.

(21) An admission system according to the invention is an admission system which further includes a ticket sales device connected to the server, in which the ticket sales device includes transmitting means that transmits decision on saving admission to the server, in which the server further includes decision means for saving admission that receives the decision on saving admission and updates the ticket information recorded in the recording part with an information piece “saving admission permitted”, and in which the judging means for admission of the control device for entrance gate refers to the ticket information and determines to permit admission if at least today is the day when the pertinent ticket permits admission or if “saving admission permitted” applies to the pertinent ticket.

Therefore, the saving admission can also be controlled the same way as the normal admission by the gate control device.

(22) An admission system according to the invention is an admission system in which the ticket sales device includes transmitting means that transmits application for saving admission to the server, in which the server includes obtaining means for fundamental information that receives the pertinent application for saving admission and obtains fundamental information including at least prediction information of on-site guests, in which the transmitting means of the server transmits the pertinent fundamental information to the ticket sales device, and in which the ticket sales device includes judging means for saving admission possibility that judges the possibility of saving admission based on the fundamental information and transmits decision on saving admission to the server when determining that the saving admission is possible.

Therefore, decision can be made after it is determined whether or not the saving admission is possible.

(23) An admission system according to the invention is an admission system which corresponds to a ticket permitting admission to facilities on a given day within a predetermined period, and includes a control device for entrance gate disposed at an entrance to the facilities and a server communicably connected to the control device for entrance gate, in which

the server includes: a recording part that records ticket information which includes a ticket ID of the ticket and admission day information indicating a day when the pertinent ticket permits admission; obtaining means for ticket information that obtains ticket information corresponding to the pertinent ticket ID transmitted from the control device for entrance gate; and transmitting means that transmits the ticket information to the control device for entrance gate via a transmission part, and

in which the control device for entrance gate includes: obtaining means for ticket ID that obtains a ticket ID from a ticket possessed by a user; transmitting means that transmits the obtained ticket ID to the server via the transmission part; judging means for admission that obtains admission day information of the pertinent ticket based on the ticket information transmitted from the server and determines whether or not at least today is the day when the pertinent ticket permits admission; and control means that outputs “admitted/unadmitted” to a display part based on a judgment result of the judging means for admission.

Therefore, the system can increase the number of sales of the annual passports relative to the upper limit of on-site guests. Whether or not the admission is permitted can be easily confirmed at the entrance gate.

(24) An admission system according to the invention is an admission system which corresponds to a ticket permitting admission to facilities on a given day within a predetermined period, and includes a control device for entrance gate disposed at an entrance to the facilities and a server communicably connected to the control device for entrance gate, in which

the server includes: a recording part that records ticket information which includes a ticket ID of the ticket and admission day information indicating a day when the pertinent ticket permits admission and records prediction information of on-site guests; obtaining means for ticket information that obtains ticket information corresponding to the pertinent ticket ID transmitted from the control device for entrance gate; obtaining means for fundamental information that receives request for fundamental information transmitted from the control device for entrance gate and obtains fundamental information including at least the prediction information of on-site guests, and transmitting means that transmits the ticket information and the fundamental information to the control device for entrance gate via a transmission part, and

in which the control device for entrance gate includes: obtaining means for ticket ID that obtains a ticket ID from a ticket possessed by a user; transmitting means that transmits the obtained ticket ID to the server via the transmission part; judging means for admission that obtains admission day information of the pertinent ticket based on the ticket information transmitted from the server, determines whether or not at least today is the day when the pertinent ticket permits admission, and transmits to the server request for fundamental information used for judgment of the possibility of saving admission when determining not to permit admission; judging means for saving admission possibility that determines, based on the fundamental information transmitted from the server, whether or not the predicted number of on-site guests for today leaves room relative to an upper limit of the on-site guests and determines that the saving admission is possible if there is some room or determines that the saving admission is impossible if there is little room; and control means that outputs “admitted/unadmitted” to a display part based on a judgment result of the judging means for admission, and that in the case of “admission unpermitted”, outputs “saving admission possible/impossible” to the display part based on a judgment result of the judging means for saving admission possibility.

Therefore, the system can provide the possibility of saving admission to a guest who mistakenly intends to enter the facilities.

The “recording part” means one that can at least record the ticket information or a concept that includes those magnetically, electrically, optically or chemically record the information. In the embodiments, a hard disk 148 is equivalent to this concept.

The “admission day information” means a concept that includes not only information that indicates a day when the admission is permitted but also information that indicates a day when the admission is not permitted, accordingly suggesting the day when the admission is permitted.

In the embodiments, the “judging means for admission” is equivalent to Step S43 and Step S44.

In the embodiments, the “transmitting means” is equivalent to Step S22, S50, S51, S511 or the like.

In the embodiments, the “judging means for saving admission possibility” is equivalent to Step S442.

In the embodiments, the “decision means for saving admission” is equivalent to Steps S82 and S83.

In the embodiments, the “control means” is equivalent to Steps S27, S30 and S291.

### BRIEF DESCRIPTION OF THE DRAWINGS

FIG. 1a is a functional block diagram of an admission system (adapted to determine whether or not to permit admission to facilities by means of a server 4) according to a first embodiment of the invention;

FIG. 1b is a functional block diagram of an admission system (adapted to judge whether or not to permit admission to facilities by means of a control device for entrance gate 2) according to the first embodiment of the invention;

FIG. 2 is a diagram showing a hardware configuration of the admission system;

FIG. 3 is a diagram showing a hardware configuration of the control device for entrance gate 2;

FIG. 4 is a diagram showing a hardware configuration of a ticket sales device 5;

FIG. 5 is a diagram showing a hardware configuration of the server 4;

FIG. 6 is a flow chart of a ticket sales process;

FIG. 7 shows an exemplary ticket information DB:

FIG. 8 shows an exemplary annual passport 20;

FIG. 9a is a flow chart of admission process;

FIG. 9b is the flow chart of admission process;

FIG. 9c is the flow chart of admission process;

FIG. 10a is a functional block diagram of an admission system (adapted to judge possibility of saving admission by means of the server 4) according to a second embodiment of the invention;

FIG. 10b is a functional block diagram of the admission system (adapted to judge possibility of saving admission by means of control device for gate terminal) according to the second embodiment of the invention;

FIG. 11a is a flow chart of admission process;

FIG. 11b is the flow chart of admission process;

FIG. 11c is the flow chart of admission process;

FIG. 11d is the flow chart of admission process;

FIG. 12 shows an exemplary ticket information DB:

FIG. 13 shows exemplary prediction information of on-site guests;

FIG. 14 is a flow chart of saving process;

FIG. 15a is a flow chart of admission process corresponding to the system of FIG. 1b;

FIG. 15b is the flow chart of admission process corresponding to the system of FIG. 1b;

FIG. 16a is a flow chart of admission process corresponding to the system of FIG. 10b;

FIG. 16b is the flow chart of admission process corresponding to the system of FIG. 10b;

FIG. 17 is a flow chart of saving process corresponding to the system of FIG. 10b; and

FIG. 18 is a flow chart of saving possibility judgment corresponding to the system of FIG. 10b.

### EMBODIMENTS FOR CARRYING OUT THE INVENTION

### 1. First Embodiment

1.1 System Outline

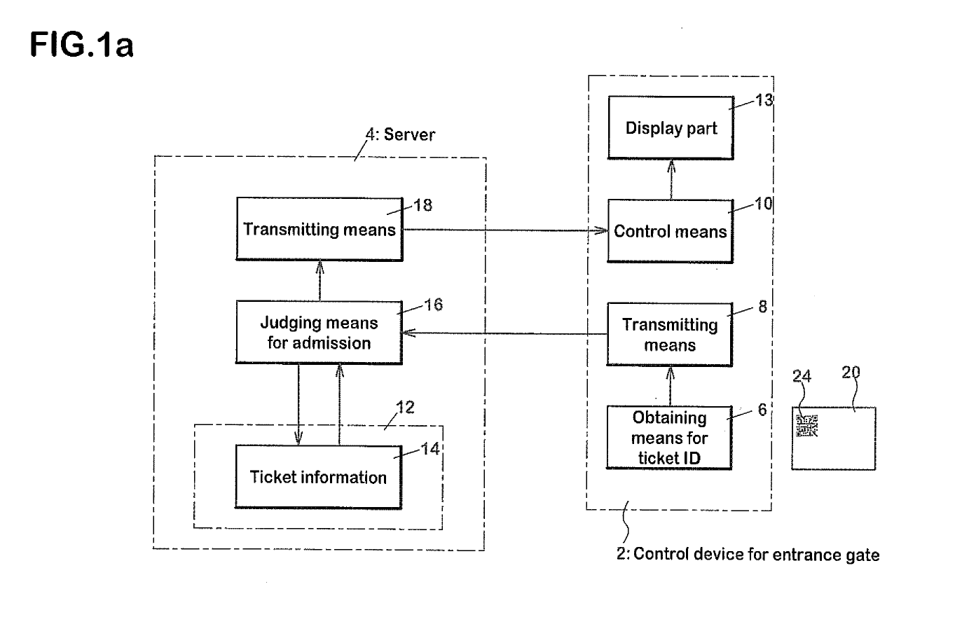

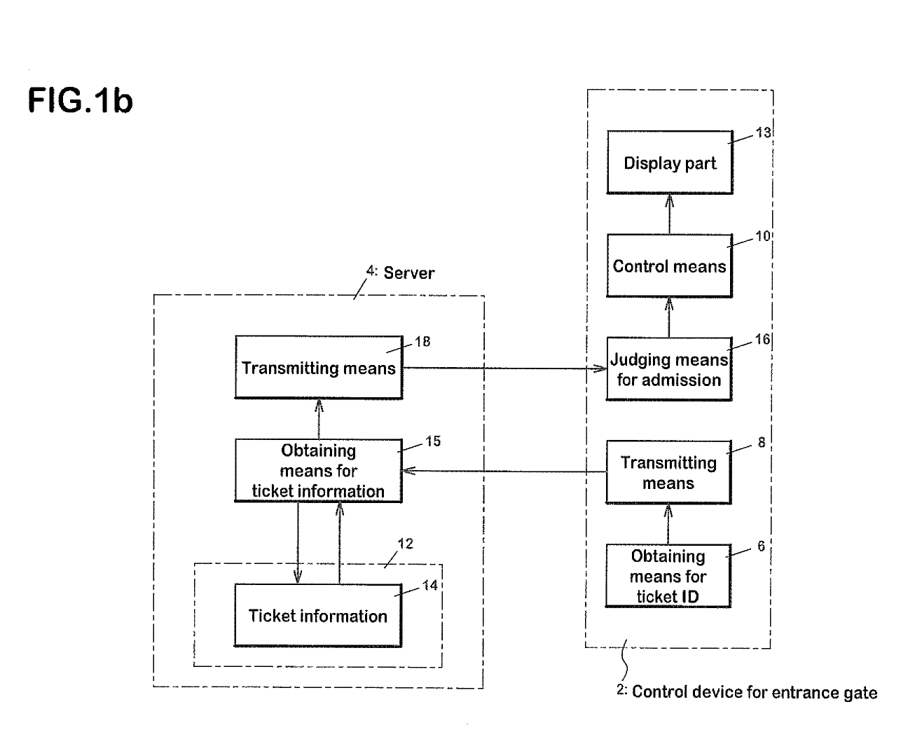

FIG. 1a shows a functional block diagram of an admission system according to a first embodiment of the invention. This admission system includes a control device for entrance gate 2 and a server 4.

An annual passport 20 as a ticket is available as a type that permits admission on odd-numbered days and a type that permits admission on even-numbered days. A QR code (trademark) 24 with an embedded ticket ID is printed on the annual passport 20.

Ticket information 14 is recorded in a recording part 12 of the server 4. The ticket information 14 includes the ticket ID and admission day information indicating on which of the odd-numbered day and the even-numbered day the admission is permitted.

Obtaining means for ticket ID 6 of the control device for entrance gate 2 obtains the ticket ID by scanning the QR code (trademark) of the annual passport 20 which is subjected to a reader by a user. Transmitting means 8 of the control device for entrance gate 2 transmits the obtained ticket ID to the server 4.

Judging means for admission 16 of the server 4 fetches from the recording part 12 the ticket information 14 corresponding to the ticket ID transmitted from the control device for entrance gate 2. Then, the judging means for admission 16 determines which of “the odd-numbered day” and “the even-numbered day” is the admission day of the annual passport 20. Further, the judging means for admission 16 determines whether today is the odd-numbered day or the even-numbered day, so as to determine whether or not today matches the admission day information of the annual passport 20. If it matches, the judging means determines to permit admission. Otherwise, the judging means determines not to permit admission.

Transmitting means 18 of the server 4 transmits a result of judgment (whether or not the admission is permitted) of the judging means for admission 16 to the control device for entrance gate 2 from which the above ticket ID was transmitted.

Control means 10 of the control device for entrance gate 2 receives “admitted/unadmitted” from the server 4 and controls a display part 13 to display accordingly. In a case where a display is used as the display part 13, for example, whether or not the user having the ticket is admitted can be shown on this display.

1.2 Hardware Configuration of the System

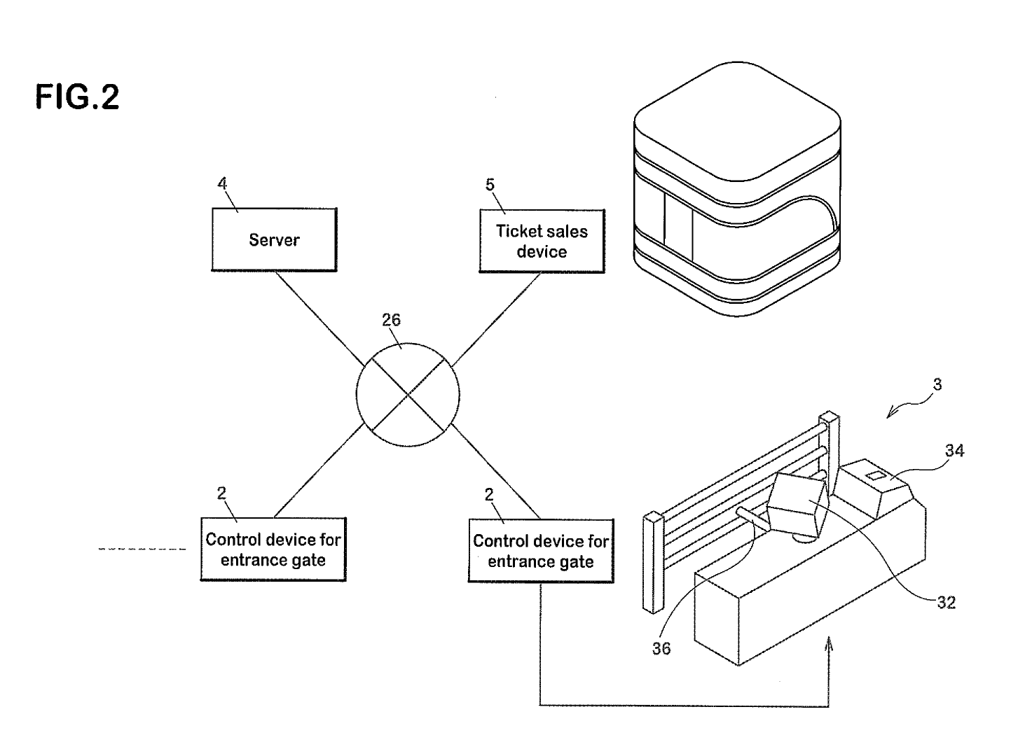

FIG. 2 shows a hardware configuration of the admission system of FIG. 1a. The server 4 is connected to the control device for entrance gate 2 via a dedicated line 26. The control device for entrance gate 2 is connected to a camera/display 32, a QR code (trademark) reader 34 and a rotation bar 36 of an entrance gate 3 in order to control these devices of the entrance gate 3 or to obtain information therefrom. A plurality of entrance gates 3, all of which are not shown in the figure, are provided while the control devices for entrance gate 2 are provided in correspondence to the entrance gates 3, respectively.

The server 4 is also connected with a ticket sales device 5 via the dedicated line 26. The ticket sales device 5 is for the sale of tickets designating one or two admission days as well as the above-described annual passport 20.

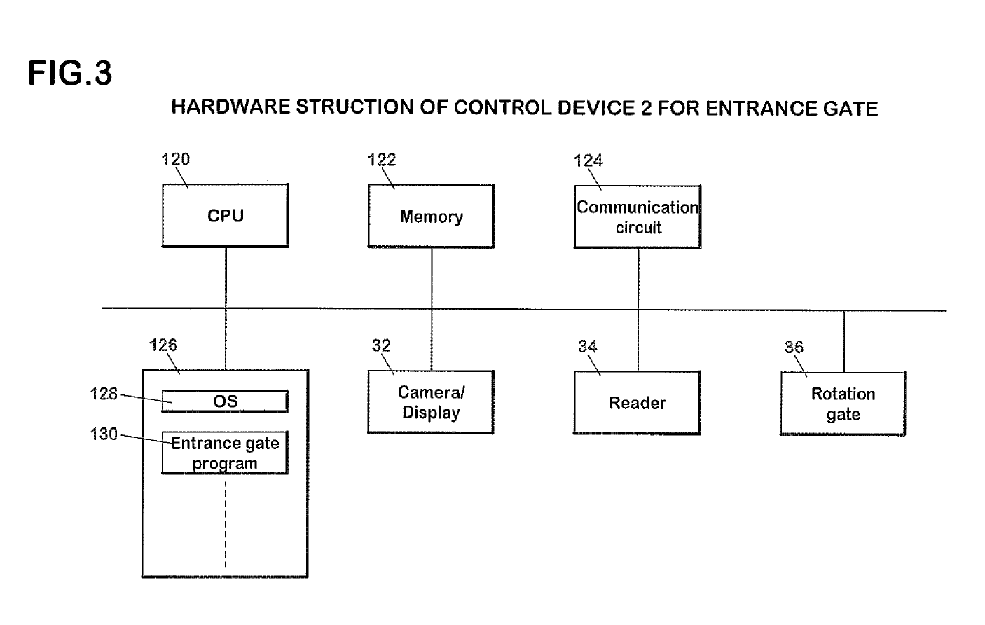

FIG. 3 shows a hardware configuration of the control device for entrance gate 2. Connected to a CPU 120 are a memory 122, a communication circuit 124, a hard disk 126, a camera/display 32, a reader 34 and a rotation gate 36. The communication circuit 124 is for communication with the server 4. The camera/display 32 has a camera disposed on a guest side and a display on a crew side.

The hard disk 126 holds an operating system 128 and an entrance gate program 130. These programs are recorded on a CD-ROM (not shown) or the like and installed in the hard disk 126. The entrance gate program 130 fulfills its function in cooperation with the operating system 128.

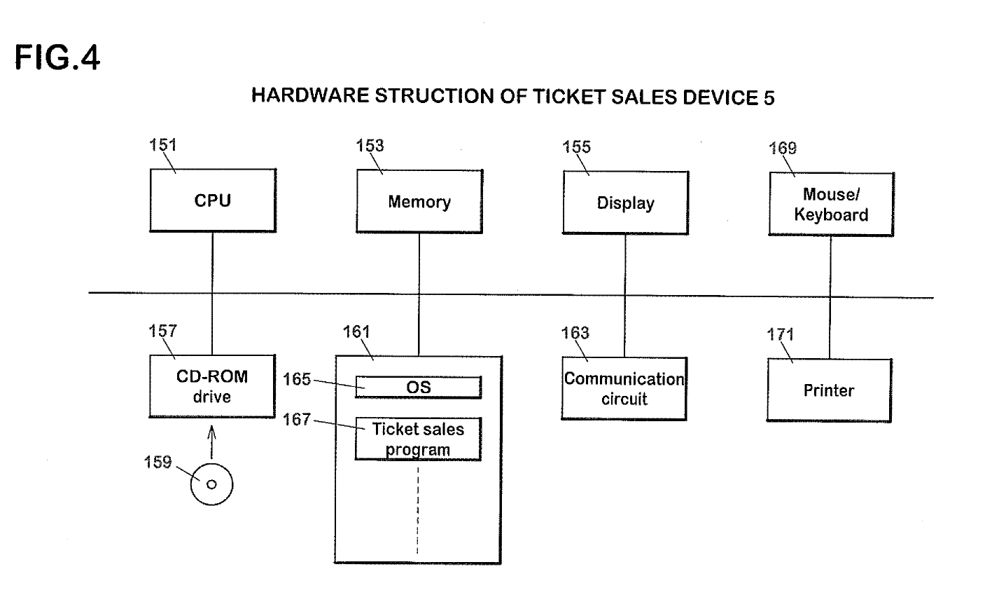

FIG. 4 shows a hardware configuration of the ticket sales device 5. Connected to a CPU 151 are a memory 153, a display 155, a CD-ROM drive 157, a hard disk 161, a communication circuit 163, a keyboard/mouse 169 and a printer 171. The communication circuit 163 is for communication with the server 4.

The hard disk 161 holds an operating system 165 and a ticket sales program 167. These programs are recorded on a CD-ROM 159 and installed in the hard disk 161 by means of the CD-ROM drive 157. The ticket sales program 167 fulfills its function in cooperation with the operating system 165.

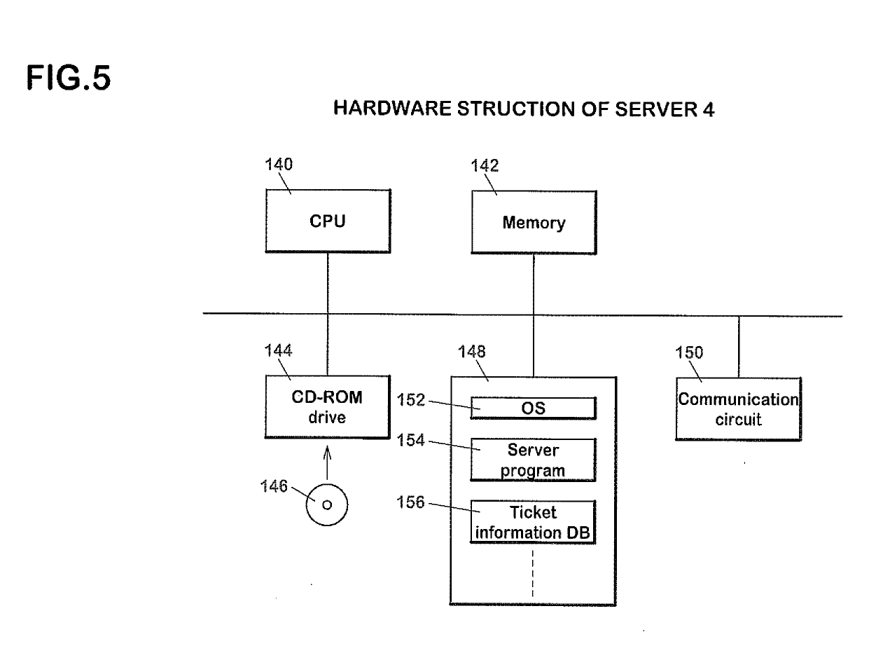

FIG. 5 shows a hardware configuration of the server 4. Connected to a CPU 140 are a memory 142, a CD-ROM drive 144, a hard disk 148 and a communication circuit 150. The communication circuit 150 is for communication with the control device for entrance gate 2 and the ticket sales device 5.

The hard disk 148 holds an operating system 152, a server program 154 and a ticket information DB 156. These programs are recorded on a CD-ROM 148 and installed in the hard disk 148 by means of the CD-ROM drive 144. The server program 154 fulfills its function in cooperation with the operating system 152.

1.3 Process at Time of Ticket Sales

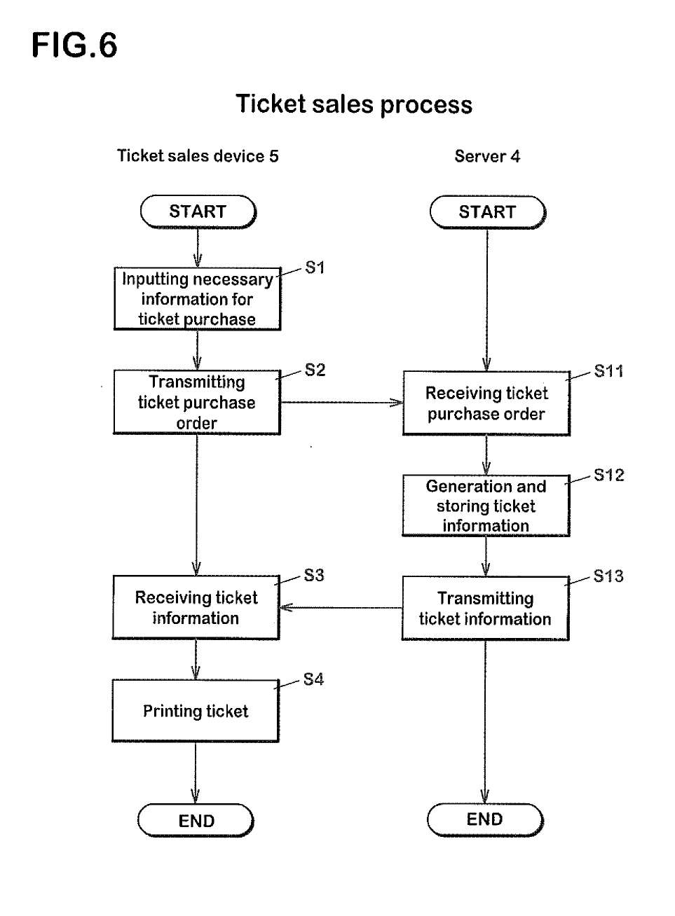

FIG. 6 shows a flow chart of the ticket sales program 167 and the server program 154 executed at the time of ticket sales. The CPU 151 of the ticket sales device 5 (hereinafter, sometimes abbreviated as “ticket sales device 5”) receives information necessary for ticket purchase which is inputted through the keyboard/mouse 168 (Step S1). The information necessary for ticket purchase includes, for example, the type of ticket (annual passport or one-day ticket, two-day ticket and 1.5-day ticket (permitting admission after 15:00 on the first day and all-day admission on the second day), each designating admission day(s) and the like); admission day for the ticket designating the admission day; admission on the odd-numbered day or admission on the even-numbered day for the annual passport; and the like.

The following description is made by way of an example where an annual passport for odd-numbered admission day is purchased. The ticket sales device 5 transmits an application for ticket purchase to the server 4 via the communication circuit 162 (Step S2). The application is for the purchase of an annual passport for odd-numbered admission day.

The CPU 140 of the server 4 (hereinafter, sometimes abbreviated as “server 4”) receives the application for ticket purchase via the communication circuit 150 (Step S11). The server 4 generates ticket information based on the received application for ticket purchase and adds the generated information to the ticket information DB 156 stored on the hard disk 148 (Step S12).

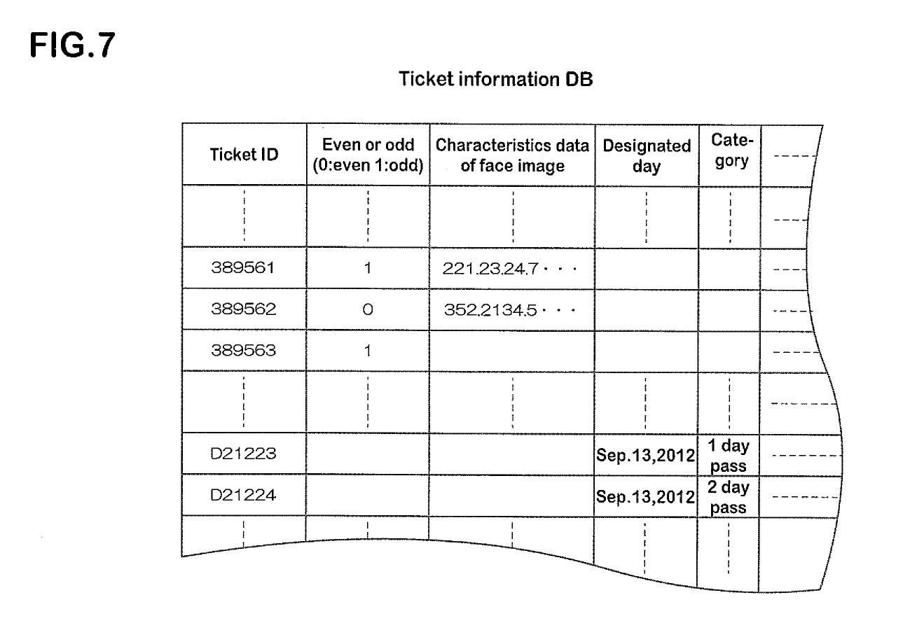

FIG. 7 shows an example of the ticket information DB 156. The ticket ID is a serial number that the server 4 assigns to the ticket in order of receipt of application for ticket purchase. Odd-even data indicates whether the admission day is the odd-numbered day or the even-numbered day, “0” representing the admission on the even-numbered day and “1” representing the admission on the odd-numbered day. According the example shown in FIG. 7, a new piece of ticket information having a ticket ID “389563” and an odd-even data “1” is generated and recorded in response to a new application for ticket purchase. Characteristics data of face image is to record imagery characteristics of the face image of a guest (such as distance of center of iris, nose, mouth or the like and positional information thereof). In this embodiment, the column of characteristic data of face image is in blank because a face image of the guest is not obtained at the time of ticket purchase.

In this embodiment, as shown in FIG. 7, the ticket ID of a ticket other than the annual passport is preceded by a character “D”. A ticket having a ticket ID “D21223”, for example, is a one-day ticket that permits admission on Sep. 13, 2012 (known from a column of designated day).

The server 4 transmits the generated ticket information to the ticket sales device 5 (Step S13). The ticket sales device 5 receives this ticket information. Subsequently, based on the received ticket information, the ticket sales device 5 prints out the annual passport 20 by means of the printer 170 (Step S4).

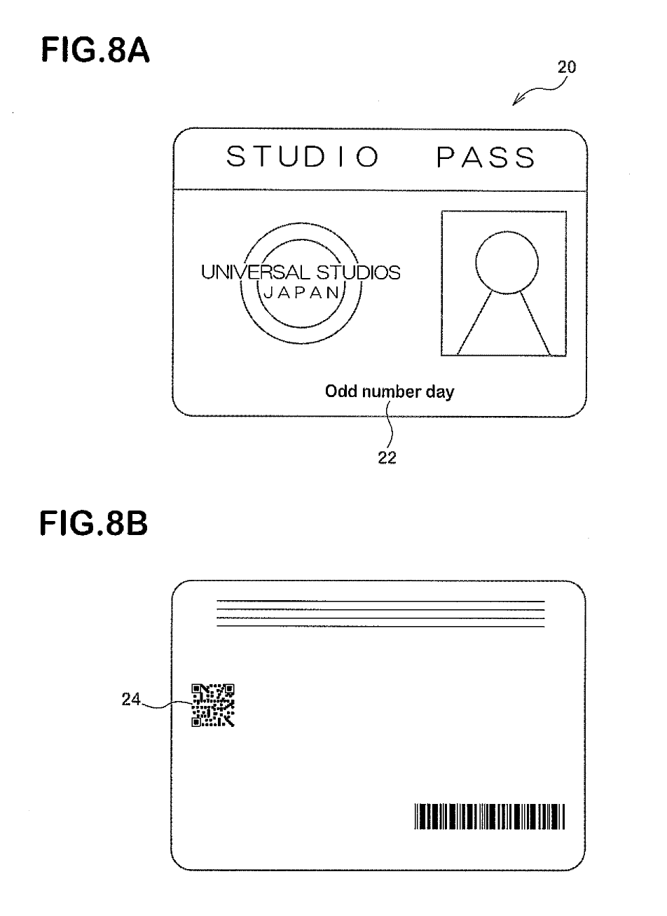

FIG. 8 shows an example of the annual passport. As shown in FIG. 8A, numerals 22 indicating on which of the odd-numbered day and the even-numbered day the admission is permitted are printed on a front side. In the example shown in the figure, the admission is permitted on the odd-numbered day. As shown in FIG. 8B, the QR code (trademark) 24 with the embedded ticket ID (here, “389653”) is printed on a backside.

The guest who purchased the ticket 20 brings this ticket 20 with him/her on the odd-numbered day so as to be permitted to enter the facilities.

1.4 Admission Process

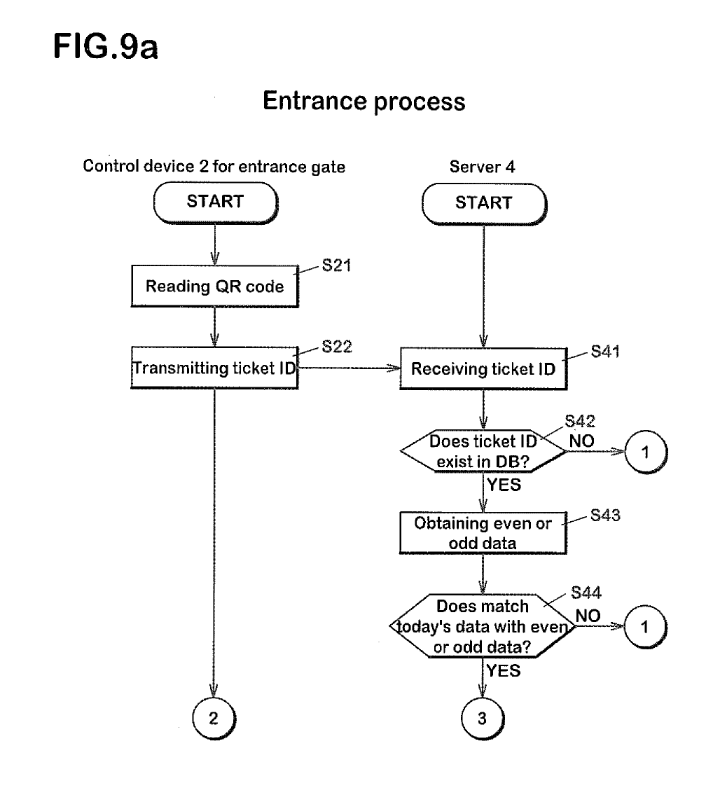

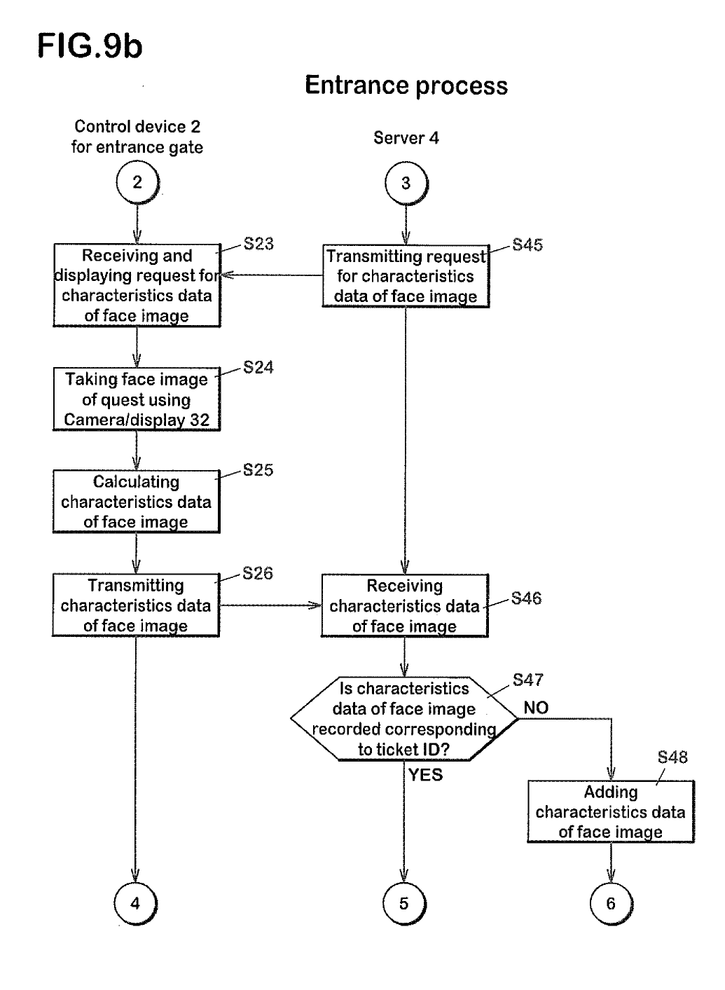

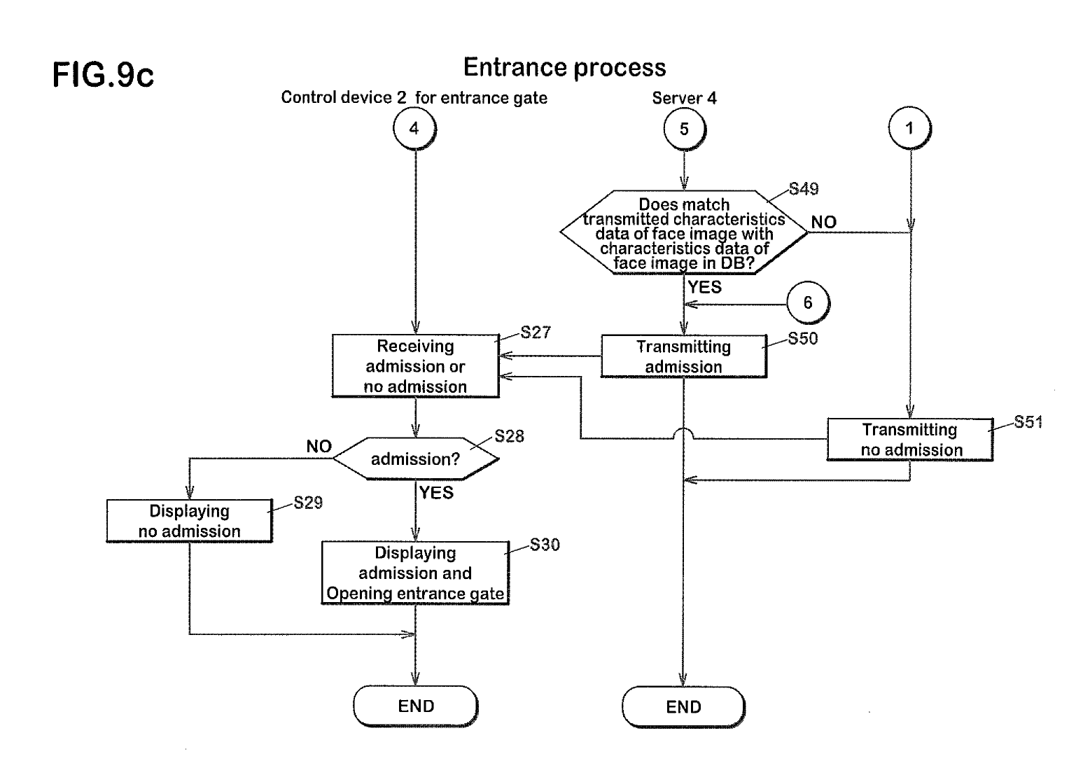

FIG. 9a to FIG. 9c show a flowchart of the entrance gate program 130 and the server program 154 executed at the time of admission. Here, description is made on an admission process for the annual passport 20.

At the entrance gate 3, the crew receives the annual passport 20 to the guest to read the QR code (trademark) 24 (see FIG. 8B) of the annual passport 20 by means of the reader 34 (see FIG. 2). The CPU 120 of the control device for entrance gate 2 (hereinafter, sometimes abbreviated as “control device for entrance gate 2”) obtains the read QR code (trademark) 24 (Step S21). Next, the control device for entrance gate 2 restores the ticket ID from the read QR code (trademark) 24 and transmits the ticket ID to the server 4 via the communication circuit 124 (Step S22). The following description is made on assumption that the ticket ID “389563” has been transmitted.

The server 4 receives the ticket ID (Step S41). Subsequently, the server 4 determines whether or not the received ticket ID is recorded in the ticket information DB 156 (see FIG. 7) (Step S42). If not, the admission is not permitted because the ticket is illegal (proceed to Step S51 in FIG. 9c). If recorded, the server obtains the odd-even data from the pertinent ticket information (Step S43). Here, the ticket ID is “389563” and hence, “1” is obtained as the odd-even data (see FIG. 7). Thus, the server 4 can identify this ticket as the annual passport for the admission on the odd-numbered day.

Next, the server 4 obtains the present date from an inner calendar circuit. The server 4 determines whether or not the odd or even number of the present date matches the odd-even data of the ticket (Step S44). If the present date is September 12 which is even-numbered and hence, the present date does not match the odd-even data “1” of the ticket ID “389563”. If unmatched, the admission is not permitted (proceed to Step S51 in FIG. 9c).

If the present date is September 13 which is odd-numbered and hence, the present date matches the odd-even data “1” of the ticket ID “389563”. If it matches, the server 4 executes an identification process for the guest based on face image.

First, the server 4 transmits request for characteristics data of face image to the control device for entrance gate 2 (Step S45). The control device for entrance gate 2 receives the request for characteristics data of face image and shows this request on a display of the camera/display 32 (Step S23). For example, the server displays a message saying “Please photograph a face of the guest with the camera”. In response to this, the crew photographs the face of the guest with the camera of the camera/display 32. When a photographing end button is pressed, the control device for entrance gate 2 fetches the face image of the guest (Step S24).

Next, the control device for entrance gate 2 calculates characteristics data of the fetched face image of the guest (Step S25). For example, a distance between the centers of the right eye and the left eye, as well as a position of the right eye, a position of the left eye, a position of the nose, a position of the right ear, a position of the left ear and the like with respect to the origin defined by a centroid position of a facial contour are calculated as the characteristics data. The control device for entrance gate 2 transmits the calculated characteristics data of face image to the server 4 (Step S26).

The server 4 receives this characteristics data (Step S46). The server 4 checks the subject ticket (here, the ticket with the ticket ID “389563”) to determine whether or not the characteristics data of face image is recorded in the ticket information (Step S47). If recorded, the server compares the recorded characteristics data with the transmitted characteristics data and determines whether or not the recorded data matches the transmitted data within a predetermined range of similarity (Step S49). Namely, the server determines whether or not the same guest as the guest of the registered face image is passing the gate device 3. If it matches, the server proceeds to Step S50 and determines to permit admission.

If it is determined in Step S47 that the characteristics data of face image is not recorded in the ticket information of the subject ticket (here, the ticket with the ticket ID “389563”), the server proceeds to Step S48. Since the ticket ID “389563” is used for the first time after purchase, the characteristics data of face image thereof is not recorded. Therefore, the server proceeds to Step S48.

In Step S48, the server 4 records the characteristics data of face image transmitted from the control device for entrance gate 2 as the ticket information of the pertinent ticket. Namely, the server records the characteristics data of face image in the column of characteristics data of face image for the ticket ID “389563” shown in FIG. 7. This characteristics data will be used for the identification in Step S49 at the subsequent admission process.

Next, the server 4 proceeds to Step S50 to determine to permit admission and transmits “admitted” to the control device for entrance gate 2 (Step S50). In the first admission process, just as described, the characteristics data of face image is registered but identification based on the characteristics data of face image is not carried out.

Note that in a case where the ticket ID is not found in Step S42, where the odd or even number of the present date does not match the odd-even data in Step S44, or where the identity is not verified based on the face image in Step S49, the server 4 transmits “unadmitted” to the control device for entrance gate 2 (Step S51).

The control device for entrance gate 2 receives a judgment result “admitted” or “unadmitted” (Step S27). If the received judgment result is “admitted”, the control device for entrance gate 2 displays a sign (such as o) representing “admitted” on the display of the camera/display 32. Further, the control device for entrance gate 2 controllably rotates the gate 36 to permit the guest to pass the gate (Step S30).

On the other hand, if the received judgment result is “unadmitted”, the control device for entrance gate 2 displays a sign (such as x) representing “unadmitted” on the display of the camera/display 32. Further, the control device for entrance gate 2 keeps the gate 36 locked (Step S29).

In the above-described manner, whether or not to permit admission can be determined by determining whether the annual passport 20 is for the admission on the odd-numbered day or the admission on the even-numbered day.

1.5 Other Features

In the above embodiment, the day when the admission is permitted is recorded as the admission day information. However, the admission day may be indicated by recording day(s) when the admission is not permitted in a predetermined period.

In the above embodiment, whether or not the admission is admitted is shown on the display but may also be indicated by a lamp. Alternatively, whether or not the admission is permitted may also be indicated by sound.

The above embodiment has been described with reference to the case where the invention is applied to the annual passport that permits the admission on the odd-numbered day or the even-numbered day. However, the invention may generally be applied to a case where the days of the year are classified into two groups so as to provide two types of annual passports, such as annual passports each permitting the admission on the odd-numbered month or the even-numbered month, or annual passports each permitting the admission on the odd-numbered week or the even-numbered week from the fore-end of the year. Further, there may be annual passports which permit the admission from Monday to Friday and on Sunday and permit the admission from Monday to Friday and on Saturday, so that the admission days partially overlap with each other.

The above embodiment has been described with reference to the case where the invention is applied to the annual passport. However, the invention may generally be applied to tickets permitting repeated admissions for a predetermined period, such as a six-month passport, one-month passport, and seasonal passport. Alternatively, the invention may also be applied to a ticket that permits the admission only on one day (or two or more consecutive days) in a predetermined period.

The above embodiment has been described with reference to the case where the two types of annual passports for the odd-numbered admission day and for the even-numbered admission day are provided. However, there may also be provided three types of annual passports such as an annual passport permitting the admission on the first day, fourth day, seventh day, . . . of each month, an annual passport permitting the admission on the second day, fifth day, eighth day, . . . of each month, and an annual passport permitting the admission on the third day, sixth day, ninth day, . . . of each month. Further, there may also be provided four or more types of annual passports.

In the above embodiment, the control device for entrance gate 2 controls locking and unlocking of the gate 36. Alternatively, whether or not to permit the admission is notified to the crew (or to the guest, as well), so that the crew may permit the guest to enter or not permit the admission.

The above description is made only on the admission process for the annual passport 20. However, the server 4 is adapted to make judgment of admission about the other tickets, such as a one-day ticket. As to the one-day ticket, for example, the judgment of admission is made by determining whether or not the present date matches the designated day recorded on the ticket.

In the above embodiment, the ticket ID is embedded in the QR code (trademark) so as to be read out. However, the ticket ID may also be recorded on an IC chip of a cell-phone or the like and read out. In this case, the annual passport is electronically recorded in the cell-phone.

In the above embodiment, the identification based on the face image is carried out. However, this identification need not be performed. In the above embodiment, the server performs the face identification. Alternatively, the server may transmit the characteristics data to the control device for entrance gate so that the control device for entrance gate can perform the face identification process.

In the above embodiment, the rotation bar is used as the entrance gate 3. However, an opening and closing device such as installed at a ticket wicket of a station may be used. Further, the opening and shutting device need not be provided.

In the above embodiment, the admission is permitted on days that are in a predetermined period and specified according to a predetermined rule (for example, odd-numbered days/even-numbered days). However, the admission is permitted on the days that are in the predetermined period and specified according to the predetermined rule (for example, odd-numbered days/even-numbered days), but the admission may not be permitted on a particular exceptional day previously defined (for example, a day when a heavy congestion is expected to occur). Otherwise, such an exceptional day is not set previously specified but may be determined a predetermined number of days before the pertinent exceptional day and the guest may be notified.

In the above embodiment, the server 4 determines whether or not to permit admission, as shown in FIG. 1a. As shown in FIG. 1b, however, the decision may also be made by the control device for entrance gate 2.

The obtaining means for ticket ID 6 of the control device for entrance gate 2 obtains the ticket ID by scanning the QR code (trademark) of the annual passport 20 which is subjected to the reader by the user. The transmitting means 8 of the control device for entrance gate 2 transmits the obtained ticket ID to the server 4.

Obtaining means for ticket information 15 of the server 4 fetches from the recording part 12 the ticket information 14 corresponding to the ticket ID transmitted from the control device for entrance gate 2. Transmitting means 18 of the server 4 transmits this ticket information 14 to the control device for entrance gate 2.

Receiving this ticket information, the judging means for admission 16 of the control device for entrance gate 2 determines which of the odd-numbered day and the even-numbered day is the admission day of the pertinent annual passport 20. Further, the judging means for admission 16 determines whether today is the odd-numbered day or the even-numbered day and determines whether or not the present date matches the admission day information of the pertinent annual passport 20. If it matches, the judging means determines that the admission is possible. If not, the judging means determines that the admission is impossible.

The control means 10 of the control device for entrance gate 2 receives “admitted/unadmitted” from the judging means for admission 16 and controls a display part 13 to display accordingly. In a case where a display is used as the display part 13, for example, whether or not the user having the ticket is admitted can be shown on this display.

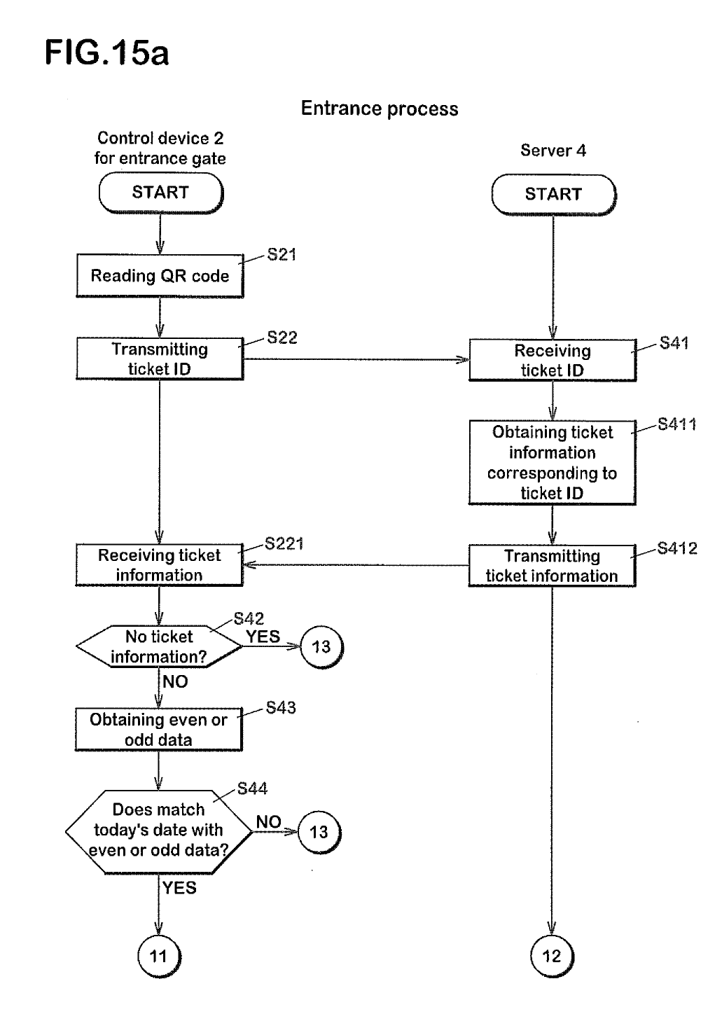

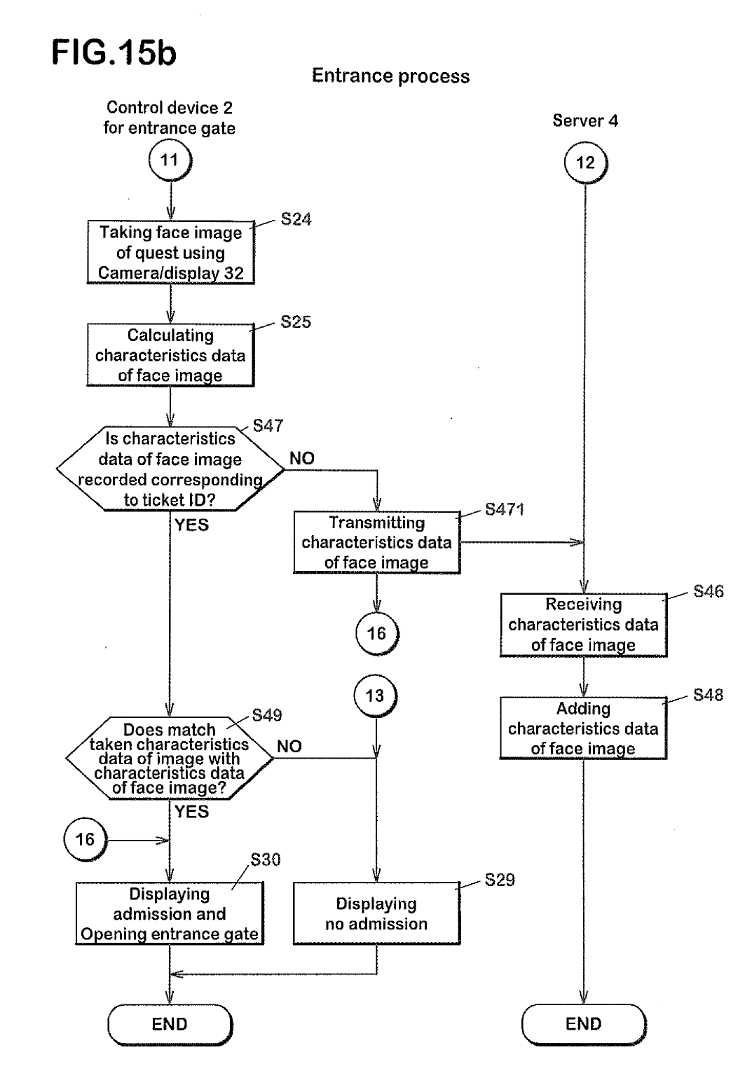

In the system of FIG. 1b, the processes corresponding to the respective means are the same as those in the system of FIG. 1a. A flow chart of an admission process by the system of FIG. 1b is shown in FIG. 15a and FIG. 15b.

In the above embodiment, as shown in FIG. 6, the ticket ID is generated by the server 4. However, the ticket ID may be generated by the ticket sales device 5. The ticket ID may be transmitted to the server 4 and recorded.

The above examples of modification may also be applied to a second embodiment so long as the examples do not deviate from the scope of the invention.

### 2. Second Embodiment

2.1 System Outline

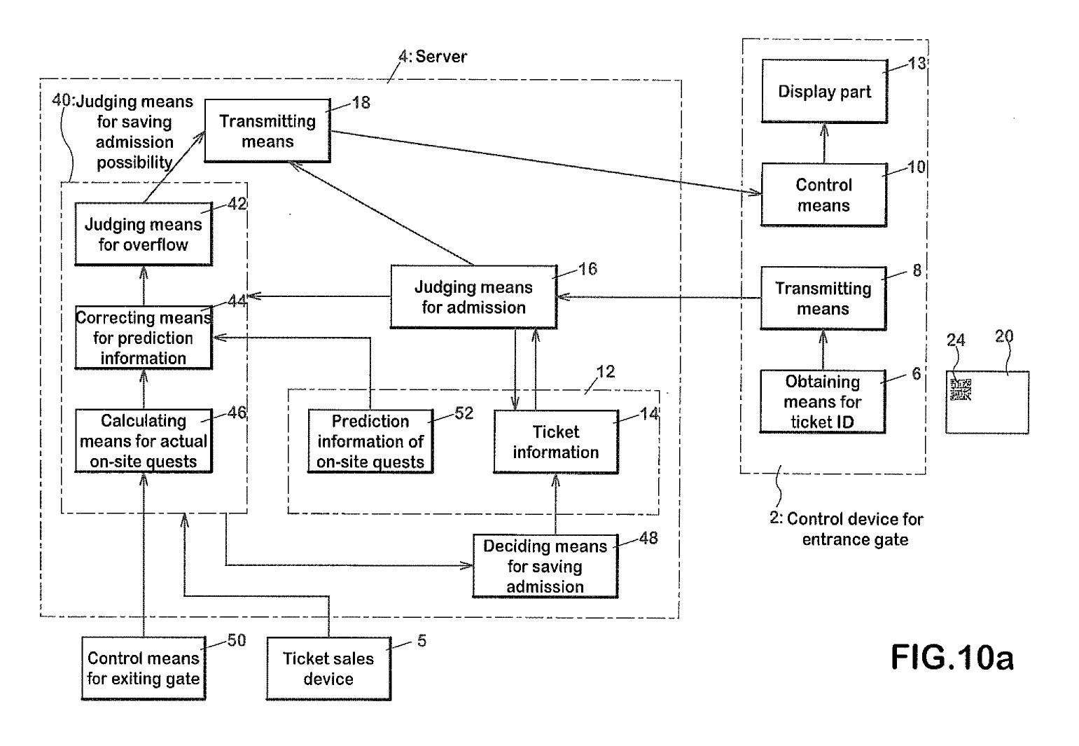

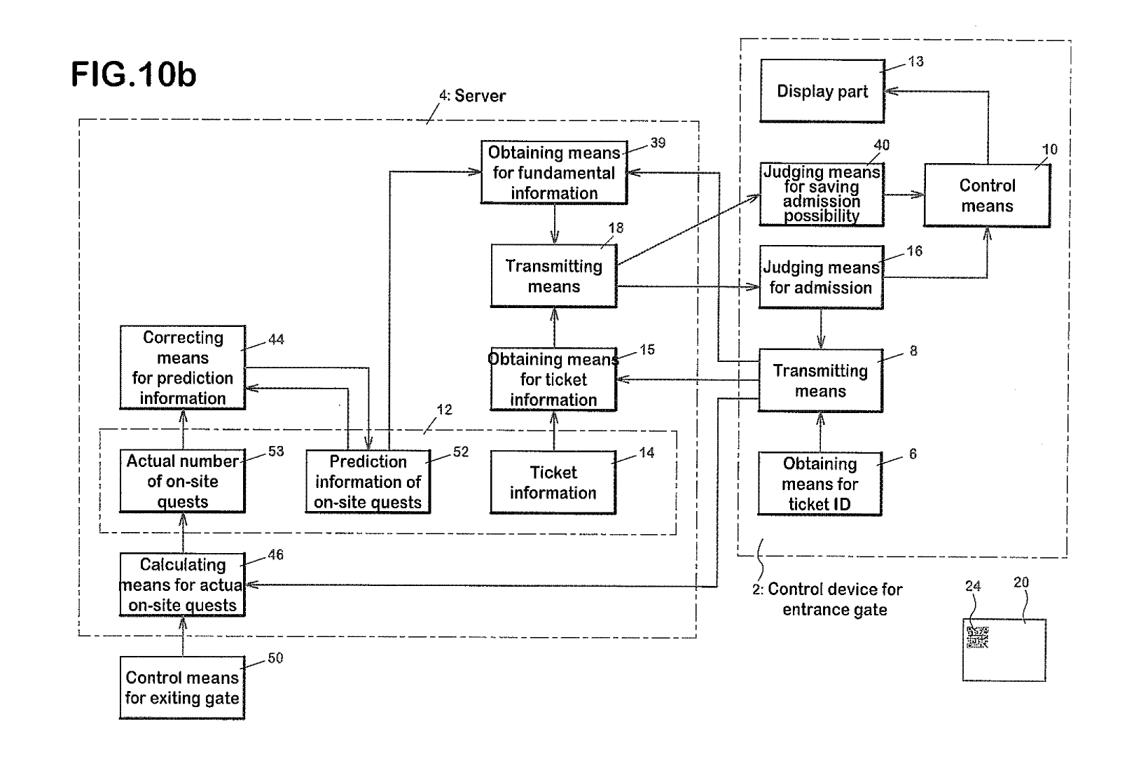

FIG. 10a shows a functional block diagram of an admission system according to a second embodiment of the invention. This admission system includes the control device for entrance gate 2, the server 4 and the ticket sales device 5.

According to the first embodiment, when a guest having an annual passport 20 for the odd-numbered admission day mistakenly visits the facilities, the guest cannot gain admission with this ticket. If the guest desires so much to gain the admission, the guest must purchase a one-day ticket or the like.

As described above, the annual passport 20 is divided into the odd-numbered day type and the even-numbered day type for the sake of enhancing guest satisfaction. In the above case, however, there is fear of frustration of the guest who is unable to gain the admission unless the guest purchases the one-day ticket. Even in the above-described case, this embodiment remedially permits the guest to gain the admission at a reasonable extra fee.

The recording part 12 of the server 4 holds prediction information of on-site guests 52 as well as the ticket information 14. The prediction information of on-site guests 52 is data on per-hour prediction of on-site guests on a day-to-day basis.

The judging means for admission 16 of the server 4 fetches from the recording part 12 the ticket information 14 corresponding to the ticket ID transmitted from the control device for entrance gate 2. Then, the judging means determines which of “the odd-numbered day” and “the even-numbered day” is the admission day of the annual passport 20. Further, the judging means for admission 16 determines whether today is the odd-numbered day or the even-numbered day, so as to determine whether or not today matches the admission day information of the annual passport 20. If it matches, the judging means determines to permit admission. Otherwise, the judging means determines not to permit admission.

Judging means for saving admission possibility 40 of the server 4 judges the possibility of saving admission when the judging means for admission 16 determines not to permit the admission. During a period elapsing between opening time and present time, calculating means for actual on-site guests 46 of the judging means for saving admission possibility 40 calculates the present number of actual on-site guests based on a cumulative number of guests who the judging means for admission 16 determined to admit and a cumulative number of exited guests detected by an exiting guest sensor.

Correcting means for prediction information 44 reads out today's prediction information of on-site guests 52 and obtains a prediction of on-site guests at a clock time corresponding to the present point of time. The correcting means compares the obtained prediction of on-site guests with the above number of actual on-site guests and corrects the prediction of on-site guests at a forward clock time of the day. Judging means for overflow 42 determines whether or not the corrected prediction of on-site guests will exceed a predetermined upper limit of on-site guests at any forward clock time of the day. If the prediction of on-site guests will exceed the upper limit at any clock time of the day, it is determined that there is no possibility of the saving admission. If the prediction of on-site guest does not exceed the upper limit at any clock time of the day, it is determined that the saving admission is possible.

Transmitting means 18 of the server 4 transmits a judgment result of the judging means for admission 16 (whether or not to permit admission), and, in the case of “unadmitted”, a judgment result of the judging means for saving admission possibility 40 (“saving admission possible/impossible”) to the control device for entrance gate 2 from which the above ticket ID was transmitted.

The control means 10 of the control device for entrance gate 2 receives “admitted/unadmitted” and/or “saving admission possible/impossible” from the server 4 and controls the display part 13 to show the received contents. In a case where a display is used as the display part 13, for example, whether or not the user possessing the ticket is admitted and whether or not the saving admission is possible can be shown on this display.

In this manner, whether or not the saving admission is possible can be notified to the user who is not admitted when the user with the annual passport 20 for the odd-numbered admission day intends to gain the admission on an even-numbered day (or vice versa).

In a case where the saving admission is possible, the guest can go to a ticket sales booth to take a procedure for the saving admission. The ticket sales device 5 is provided at the ticket sales booth. In response to a request from the guest, the crew operating the ticket sales device 5 transmits to the server 4 an application for the saving admission along with the ticket ID of the pertinent ticket.

The judging means for saving admission possibility 40 of the server 4 determines whether or not there is the possibility of the saving admission. If the saving admission is possible, decision means for saving admission 48 of the server 4 records “saving admission permitted” in the pertinent ticket information recorded in the recording part 12.

The guest goes through the procedure for saving admission at the ticket booth as described above and thereafter, presents the annual passport 20 at the entrance gate 3 the same way as in normal admission. The obtaining means for ticket ID 6 of the control device for entrance gate 2 obtains the QR code (trademark) 24 of the annual passport 20. The transmitting means 8 transmits the ticket ID embedded in the QR code (trademark) 24 to the server 4.

Even when the odd-numbered admission day or the even-numbered admission day of the annual passport 20 does not match the present date, the judging means for admission 16 of the server 4 according to this embodiment determines to permit admission if “saving admission permitted” is recorded in the ticket information. The transmitting means 18 transmits “admitted” to the control device for entrance gate 2.

The control means 10 of the control device for entrance gate 2 causes the display part 13 such as a display to show that the saving admission is permitted.

In the above-described manner, the saving admission is provided to the guest having mistakenly visited the facilities.

2.2 Hardware Configuration of the System

A hardware configuration of a system of FIG. 10a is described. The hardware configurations of the control device for entrance gate 2, ticket sales device 5 and server 4 are the same as those of the first embodiment. An exiting gate is provided with the exiting guest sensor that detects the rotation of the rotation gate. An output from this sensor is transmitted to the server 4 by the control device for entrance gate 2.

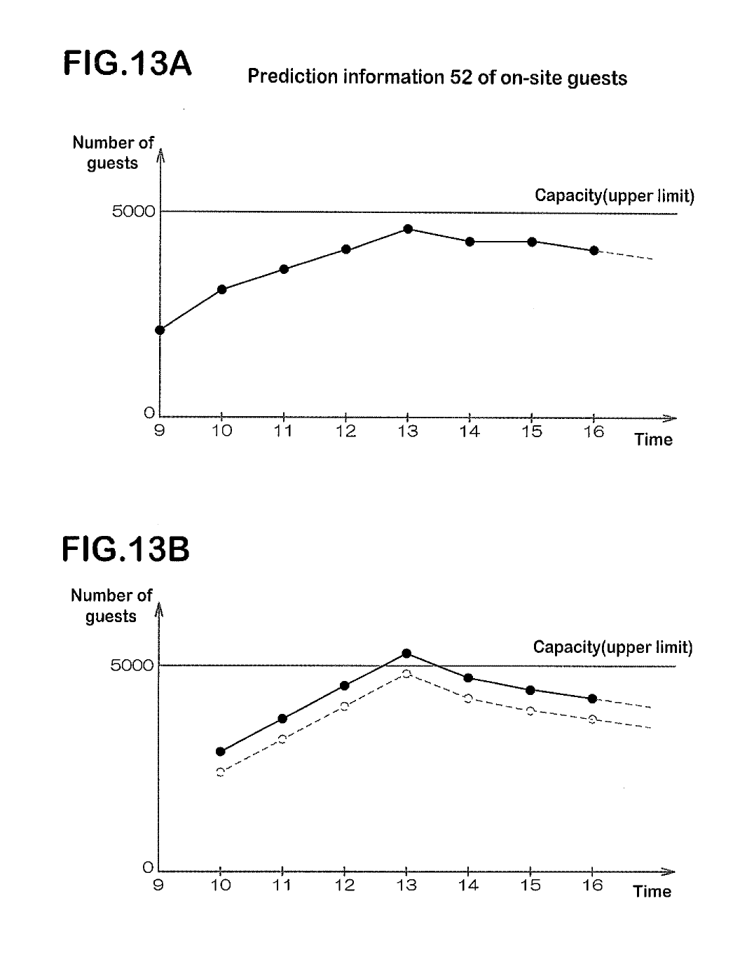

The hard disk 148 of the server 4 holds not only the ticket information DB 156 but also the prediction information of on-site guests 52. FIG. 13A shows an example of the prediction information of on-site guests 52. Although the figure graphically shows the prediction information, the information is actually composed in the form of a table of clock time and predicted number of guests. In this embodiment, the per-hour prediction of on-site guests is recorded. One-day data such as shown in FIG. 13A is recorded for all the days of the year.

2.3 Process at Time of Ticket Sales

A flow chart of the ticket sales program 166 and the server program 154 executed at the time of ticket sales is the same as that of the first embodiment (see FIG. 6).

2.4 Admission Process

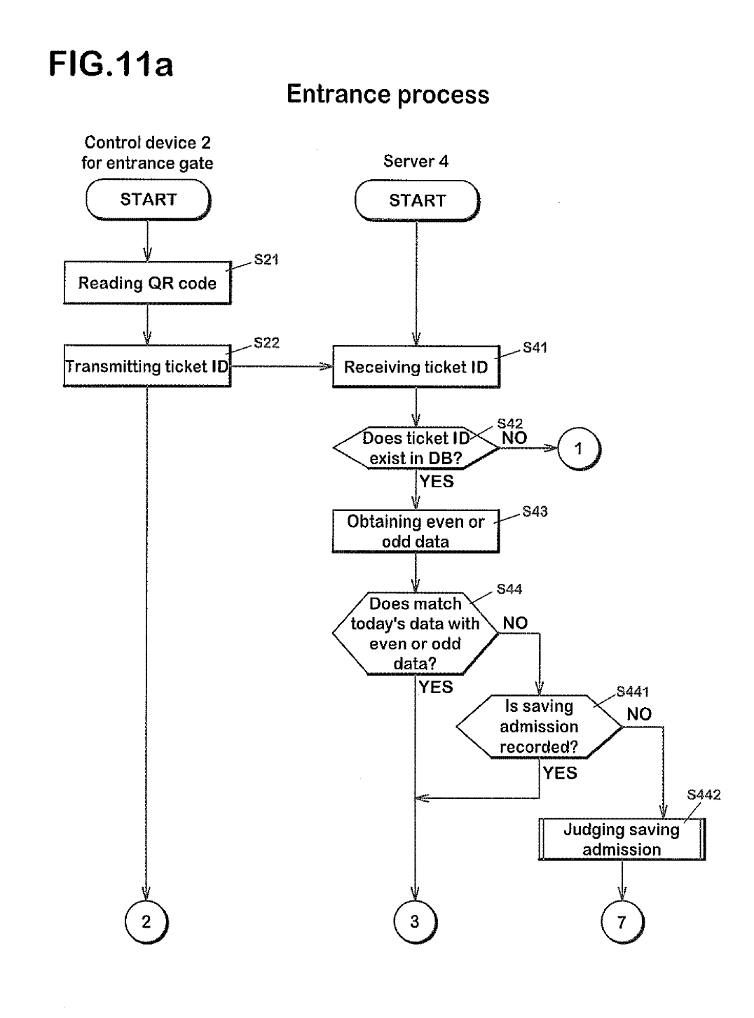

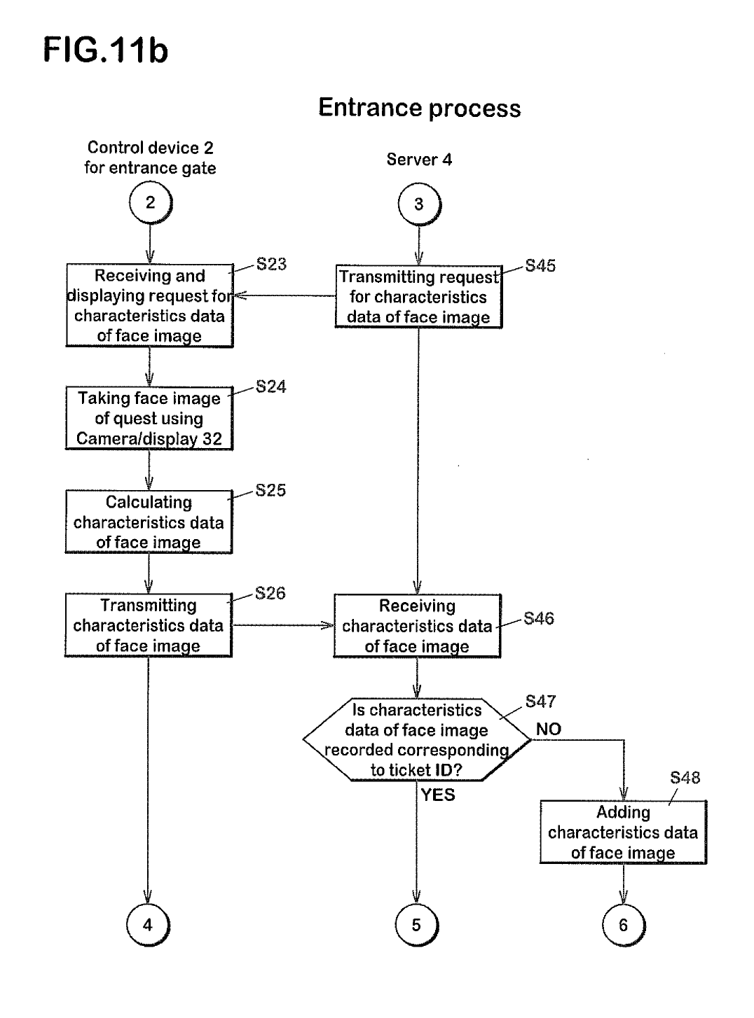

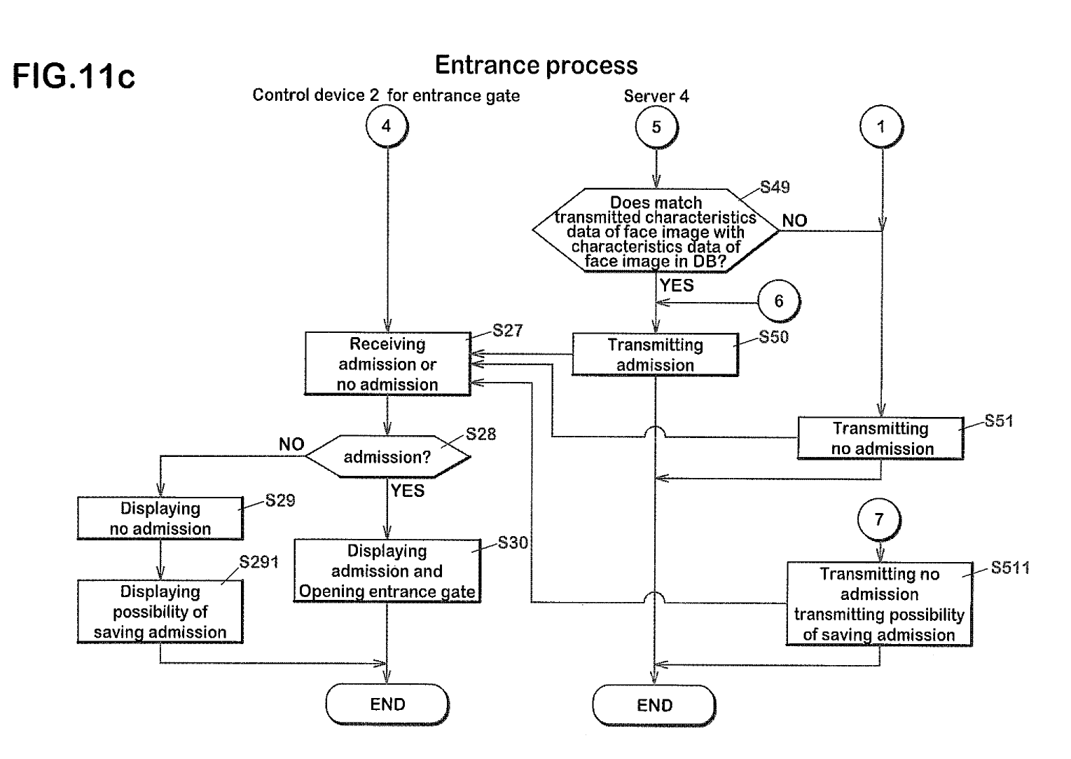

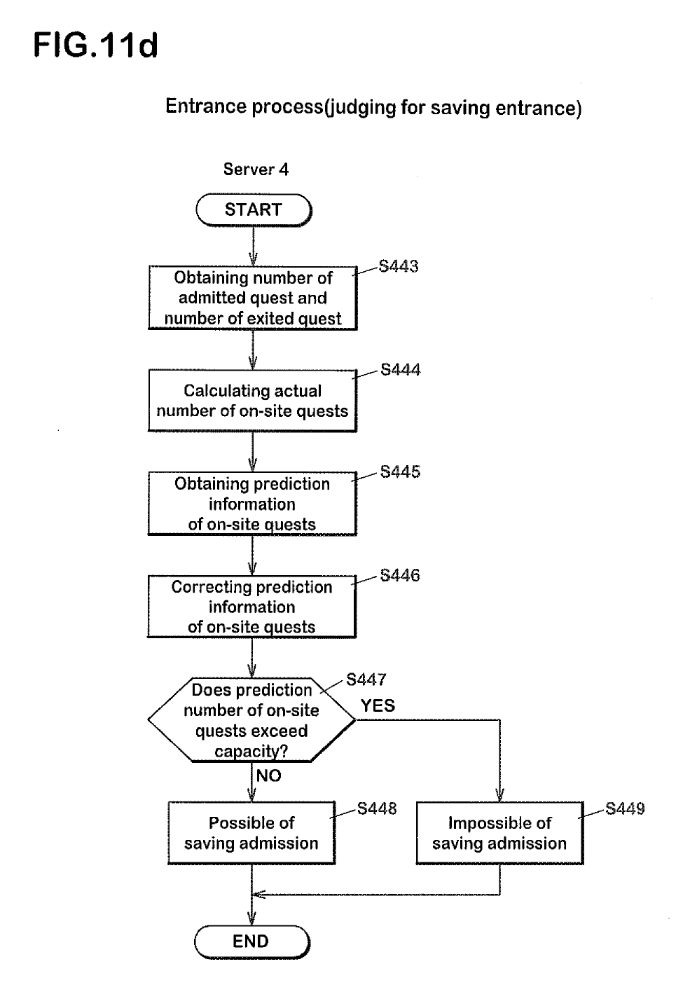

FIG. 11a to FIG. 11d show the flow chart of the entrance gate program 130 and the server program 154 executed at the time of admission.

The steps of obtaining the ticket ID from the QR code (trademark), obtaining the odd-even data based on the ticket ID, and determining whether or not the present date matches the odd-even data (Steps S21, S22, S41 to S44) are the same as in the first embodiment.

If the odd-even data and the present date match in Step S44, the server 4 and the control device for entrance gate 2 perform the identification based on the characteristics data of face image (Steps S23 to S26, S45 to S51) the same way as in the first embodiment.

If the odd-even data and the present date do not match in Step S44, the server 4 proceeds to Step S441. It is noted here that the description is made by way of example where the guest intends to gain the admission with the annual passport 20 for the odd-numbered day (ticket ID “389563”), shown in FIG. 8. Since the odd-even data and the present date do not match in Step S44, the server 4 executes Step S441.

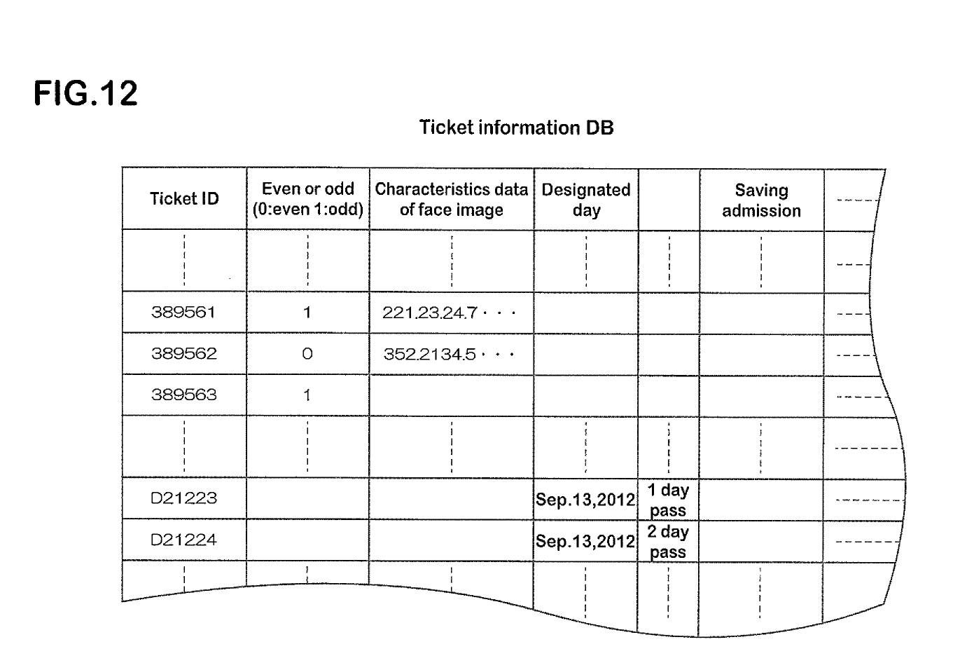

In Step S441, whether or not “saving admission permitted” is recorded in the ticket information of the pertinent ticket is determined (Step S441). As will be described hereinafter, when the procedure for saving admission is taken, “saving admission permitted” is recorded in the ticket information according to conditions. As shown in FIG. 12, “saving admission permitted” is not recorded in conjunction with the ticket ID “389563” and hence, the server 4 judges the possibility of the saving admission (Step S442).

A judging process for saving admission possibility is to determine whether or not there is the possibility of the saving admission. The details of the process are shown in FIG. 11d.

The server 4 obtains the number of admitted guests during a period elapsing between opening time and present time of the day (Step S443). The number of admitted guests may be counted and recorded on the hard disk 148 each time “admitted” is transmitted in Step S50. The number of admitted guests counts in not only those with the annual passports but also those with the other tickets (such as one-day ticket). Further, a total of the exited guests counted by means of the exiting guest sensor is fetched from the hard disk 148 (Step S443).

Next, the server 4 calculates the number of actual on-site guests by subtracting the number of exited guests from the number of admitted guests (Step S444). The server 4 reads out today's prediction information of on-site guests 52 that is recorded in the hard disk 148 (see FIG. 13A) (Step S445).

Subsequently, the server 4 determines a predicted number of guests corresponding to the present clock time based on the read prediction information of on-site guests 52. If the present clock time is 9:30, for example, a predicted number of guests are calculated by interpolating between a predicted number of guests at 9:00 and a predicted number of guests at 10:00 in FIG. 13. Provided that the predicted number of guests at 9:00 is 2000 and the predicted number of guests at 10:00 is 2600, 2300 is given as the predicted number of guests at 9:30. The server 4 compares this predicted number with the number of actual on-site guests and corrects the prediction information of on-site guests 52 according to the ratio (actual number of guests/predicted number of guests) (Step S446).

If the present number of actual on-site guests is 2760, for example, 2760/2300=1.2. Therefore, the predicted number is corrected to a value increased by 20 percent. The prediction information of on-site guests 52 corrected in this manner is represented by a solid line in FIG. 13B.

Next, the server 4 determines whether or not the corrected prediction information of on-site guests 52 will exceed the upper limit of the on-site guests at any clock time of the day (Step S447). The solid line in FIG. 13B indicates that the predicted number exceeds the upper limit (5000) at 13:00. Namely, the server 4 determines that there is little room for the saving admission and determines that there is no possibility of the saving admission (Step S449).

It is noted that if the corrected predicted number will not exceed the upper limit at any forward clock time of the day (till closing time), as indicated by the broken line in FIG. 13B, it is determined that the saving admission is possible (Step S448).

In this embodiment, the prediction information of on-site guests 52 as correction subject is corrected at any clock time by comparing the number of actual on-site guests with the previously recorded information. However, the correction may also be made by comparing the number of actual on-site guests with the latest update on the prediction information of on-site guests 52.

When the possibility of the saving admission is determined in the above-described manner, the server 4 transmits “unadmitted” and “saving admission possible” to the control device for entrance gate 2 in Step S511 shown in FIG. 11c.

Receiving this, the control device for entrance gate 2 displays “unadmitted” on the display of the camera/display 32 (Step S29). Further, the control device for entrance gate 2 displays “saving admission possible/impossible” on the display of the camera/display 32 (Step S291). For example, “x” is shown as “unadmitted”, under which “saving admission possible” or “saving admission impossible” is shown. When “x” is shown as “unadmitted”, “x” may be shown in red in the case of no possibility of saving admission while “x” may be shown in blue in the case of a possibility of saving admission. Alternatively, a blue lamp (“possible”) and a red lamp (“impossible”) or the like may be provided for indication. Instead of using display, a speaker or the like may be used to inform whether the saving admission is possible or not.

In this manner, the guest mistakenly intends to gain the admission at the entrance gate can be informed of whether the saving admission is possible or not.

2.5 Saving Process

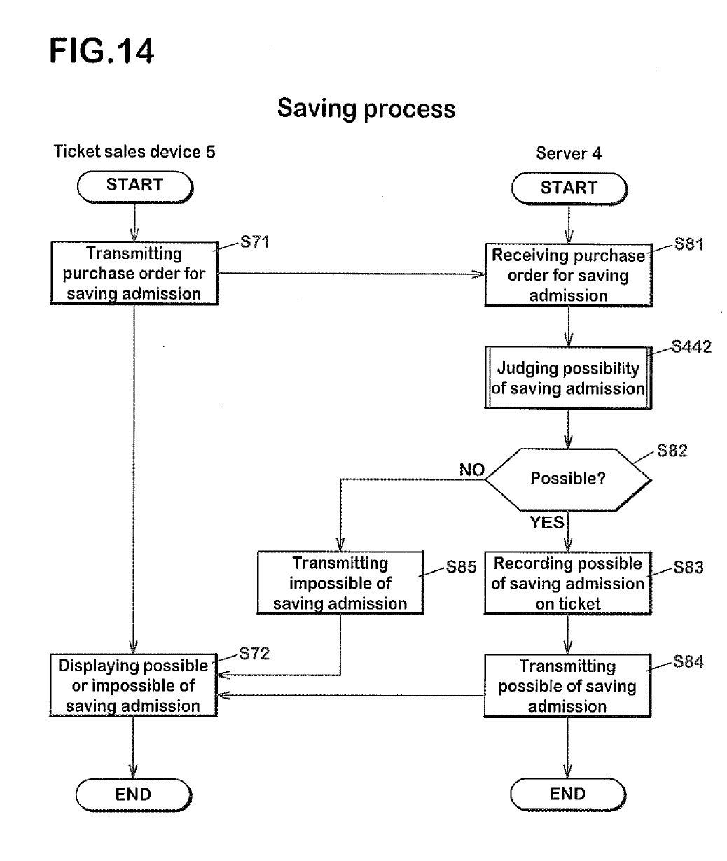

FIG. 14 shows a flow chart of the ticket sales program 166 and the server program 154 executed at the time of saving. The guest who was not admitted at the entrance gate but informed of the possibility of saving admission, as described above, applies for the saving admission at the ticket booth. Incidentally, a guest noticing a mistake may also go to the ticket booth before going to the entrance gate.

The crew at the ticket booth scans the QR code (trademark) (ticket ID) of the guest by means of the reader (not shown) connected to the ticket sales device 5. The ticket sales device 5 transmits to the server 4 the read ticket ID together with an application for saving admission (Step S71). The server 4 receives this application (Step S81).

When receiving the application for saving admission, the server 4 judges the possibility of the saving admission (Step S442). The details of the judgment of the possibility of saving admission are shown in FIG. 11d.

If the server 4 determines that there is no possibility of the saving admission (Step S82), the server transmits “saving admission unpermitted” to the ticket sales device 5 (Step S85). If the server 4 determines that the saving admission is possible (Step S82), the server records “saving admission permitted” in the ticket information (see FIG. 12) of the pertinent ticket (Step S83). Further, the server transmits “saving admission permitted” to the ticket sales device 5 (Step S84).

The ticket sales device 5 receives “saving admission permitted/unpermitted” and displays this message on the display 154 (Step S72). Thus, the crew can inform the guest of whether or not the saving admission is permitted.

In the above process, if the saving admission is possible, “saving admission permitted” is immediately recorded in the ticket information. However, “saving admission possible” may be transmitted to the ticket sales device 5 and displayed. After collecting a saving fee from the guest, the crew may click an OK button at the ticket sales device 5 so that the ticket sales device may respond to record “saving admission permitted” in the ticket information.

The guest who has gained admission in the above-described manner can enter by presenting the annual passport at the entrance gate 3 (Step S441 in FIG. 11a).

2.6 Other Features

In the above embodiment, the prediction information of on-site guests 52 is corrected with the number of actual on-site guests and thereafter, the possibility of saving admission is determined depending upon whether or not the corrected prediction information will exceed the upper limit at any forward clock time from the present clock time. Irrespective of the number of actual on-site guests, however, the possibility of saving admission may also be determined depending upon whether or not previously calculated prediction information of on-site guests 52 will exceed the upper limit at a forward clock time from the present clock time.

It is also possible to determine the saving admission to be possible till the number of actual on-site guests exceeds the upper limit.

Alternatively, the number of guests to be given the saving admission is previously determined for each day and the saving admission may be permitted till the total of the saving admissions permitted exceeds this previously determined number.

In the above embodiment, the possibility of saving admission is judged when the guest mistakenly comes to the entrance gate 3, but whether or not to permit the saving admission is not determined. That is, the guest must go to the ticket booth in order to gain the saving admission. Unless the extra fee for the saving admission is collected, however, a process of Step S83 to permit the saving admission can be performed in parallel with the judgment of the possibility of saving admission (Step S442). If the control device for entrance gate 2 is equipped with a credit-card processing device or the like, the extra fee can be paid by the credit card and the process of Step S83 to permit the saving admission can be performed immediately.

The above embodiment involves fear that even though the saving admission was determined to be possible at the entrance gate 3, the circumstances have changed when the guest reaches the ticket booth and the saving admission is determined to be impossible. This problem is prevented as follows. In a case where the saving admission is determined to be possible when the guest is at the entrance gate 3, the server 4 may record this determination on the hard disk 148 so that the guest may be preferentially given the saving admission when the guest applies for the saving admission from the ticket booth.

In the above embodiment, the guest does not know whether or not the saving admission is possible unless the ticket sales device 5 at the ticket booth sends inquiry to the server 4. However, the ticket sales device 5 may make inquiry to the server 4 at predetermined time intervals and “saving admission possible/impossible” may be shown on a display or the like on a real-time basis, the display so located at place easily viewable by the guest.

In the above embodiment, the extra fee is required for saving admission. Instead of collecting the extra fee, however, the guest is not admitted on a day supposed to be the admission day of the passport (such as when the facilities are expected to be relatively crowded) while the saving admission may be permitted instead.

In the above embodiment, the possibility of saving admission is judged when the control device for entrance gate 2 transmits the ticket ID and when the application for saving admission is transmitted from the ticket sales device 5. Alternatively, the possibility of saving admission may be judged only when the application for saving admission is transmitted from the ticket sales device 5.

In the above embodiment, the guest is to choose either the odd-numbered day or the even-numbered day when purchasing the annual passport 20. Alternatively, whether the admission day is the odd-numbered day or the even-numbered day may be determined depending upon whether the day when the first admission is permitted is the odd-numbered day or the even-numbered day. The odd-numbered or even-numbered admission day so determined may be recorded in the ticket information.

Further, after the lapse of given days after the sale, the server 4 may automatically determine the admission day to be the odd-numbered day or the even-numbered day and notify the guest of the decision by e-mail.

Further, a relatively high price may be set for an annual passport allowing choice between the odd-numbered admission day and the even-numbered admission day at the time of purchase. A relatively low price may be set for an annual passport, the admission day of which (either the odd-numbered day or the even-numbered day) is determined by the server 4 after the lapse of given days after the sale. Both types of annual passports may be sold. In this case, if the high-price tickets are out of balance between the odd-numbered admission days and the even-numbered admission days chosen at the time of purchase, e.g., the even-numbered admission days are more than the odd-numbered admission days, this imbalance can be corrected by the server 4 making decision on the odd-numbered/even-numbered admission days for the low-price tickets after the sale.

The above embodiment is adapted to save the visiting guest who has mistaken in the admission day. However, the guest may previously transmit to the server 4 a request for admission on a future day which is not supposed to be the admission day and the server 4 may determine whether or not to permit the saving admission based on the prediction information of on-site guests for the pertinent day.

In a case where the guest having the annual passport for the odd-numbered admission day desires the admission on a particular even-numbered day one month from now, for example, the pertinent guest accesses the server 4 from a PC terminal to request an application screen for saving admission. The guest enters a desired day of saving admission and transmits it to the server 4. The server 4 determines whether or not to permit the saving admission based on the prediction information of on-site guests for the pertinent day. If the saving admission is permitted, the server 4 records “saving admission permitted on the pertinent day” and transmits to the PC terminal accordingly.

In this manner, the permission of the saving admission on a particular day can be previously applied for. Alternatively, the guest may visit the ticket booth and the crew may operate a terminal of the ticket sales device 5 to perform the above application process. Further, the server 4 may also communicate with the user via e-mail or per post.

In the above embodiment, as shown in FIG. 10a, the server 4 judges the admission and the possibility of saving admission. Alternatively, as shown in FIG. 10b, the control device for entrance gate 2 may judge these items.

The recording part 12 of the server 4 holds the prediction information of on-site guests 52 and the number of actual on-site guests 53 as well as the ticket information 14. The number of actual on-site guests 53 is calculated and recorded by the calculating means for actual on-site guests 46 at predetermined time intervals.

The calculating means for actual on-site guests 46 calculates the present number of actual on-site guests based on the number of guests admitted by the control device for entrance gate 2 (equivalent to the number of admissions as the result of the judgment made by the judging means for admission 16) and the number of exited guests detected by the exiting guest sensor. The calculating means for actual on-site guests 46 records the calculation result in the recording part 12.

The prediction information of on-site guests 52 is daily data on per-hour prediction of the number of on-site guests. The correcting means for prediction information 44 corrects the prediction information of on-site guests 52 at a forward clock time based on a difference between the number of actual on-site guests at the present clock time 53 and the predicted number of on-site guests corresponding to the present clock time. The corrected prediction information of on-site guests is recorded in the recording part 12. A correction method is the same as in the forgoing embodiment.

In the above-described manner, the present number of actual on-site guests and the prediction information of on-site guests corrected with this number are recorded in the recording part 12 of the server 4.

The obtaining means for ticket ID 6 of the control device for entrance gate 2 obtains the ticket ID by scanning the QR code (trademark) of the annual passport 20 which is subjected to the reader by the user. The transmitting means 8 of the control device for entrance gate 2 transmits the obtained ticket ID to the server 4.

The obtaining means for ticket information 15 of the server 4 fetches from the recording part 12 the ticket information 14 corresponding to the ticket ID transmitted from the control device for entrance gate 2. The transmitting means 18 of the server 4 transmits this ticket information 14 to the control device for entrance gate 2.

Receiving this ticket information, the judging means for admission 16 of the control device for entrance gate 2 determines which of “the odd-numbered day” and “the even-numbered day” is the admission day of the pertinent annual passport 20. Further, the judging means for admission 16 determines whether today is the odd-numbered day or the even-numbered day and determines whether or not the present date matches the admission day information of the annual passport 20. If it matches, the judging means determines to permit the admission. Otherwise, the judging means determines not to permit the admission.

The control means 10 of the control device for entrance gate 2 receives “admitted/unadmitted” from the judging means for admission 16 and controls the display part 13 to show this message. In a case where the display is used as the display part 13, for example, whether a user possessing a ticket is admitted or not can be shown on this display. In the case of “unadmitted”, the possibility of saving admission is shown in combination, as will be described hereinafter.

When determining not to permit the admission, the judging means for admission 16 transmits a request for fundamental information for judgment of the possibility of the saving admission to the server 4 by means of the transmitting means 8.

In response to the request, the obtaining means for fundamental information 39 of the server 4 fetches the prediction information of on-site guests 52 as the fundamental information from the recording part 12. The transmitting means 18 transmits this fundamental information to the control device for entrance gate 2.

The judging means for saving admission possibility 40 of the control device for entrance gate 2 judges the possibility of saving admission based on the prediction information of on-site guests 52 as the fundamental information. The judging method is the same as that of the judging means for overflow 42 of FIG. 10a.

A judgment result of the judging means for saving admission possibility 40 is supplied to the control means 10. The control means 10 displays, at the display part 13, the possibility of saving admission together with the judgment result by the judging means for admission 16.

In this manner, the possibility of saving admission can be presented to the guest who intends to gain the admission on an even-numbered day (or vice versa) with the annual passport for the odd-numbered admission day and is not admitted.

In the case of “saving admission possible”, the guest can go to the ticket sales booth to take the procedure for saving admission. The ticket sales device 5 is provided at the ticket sales booth. In response to the request by the guest, the crew operating the ticket sales device 5 transmits to the server 4 the application for saving admission together with the ticket ID of the pertinent ticket.

The obtaining means for fundamental information 39 of the server 4 transmits the number of actual on-site guests 53 and the prediction information of on-site guests 52 to the ticket sales device 5. The judging means for saving admission possibility 40 of the ticket sales device 5 judges the possibility of the saving admission. In the case of “saving admission possible”, the ticket sales device 5 transmits “saving admission permitted” automatically or as operated by the crew. In response to this, the server 4 records “saving admission permitted” in the ticket information 14.

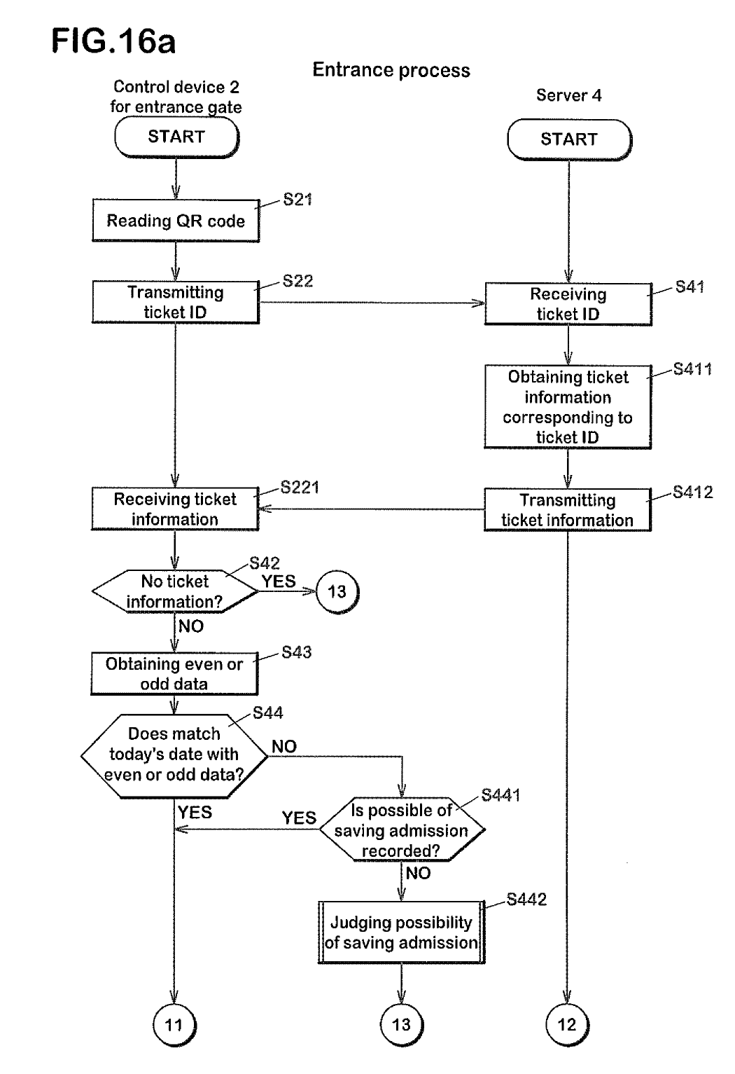

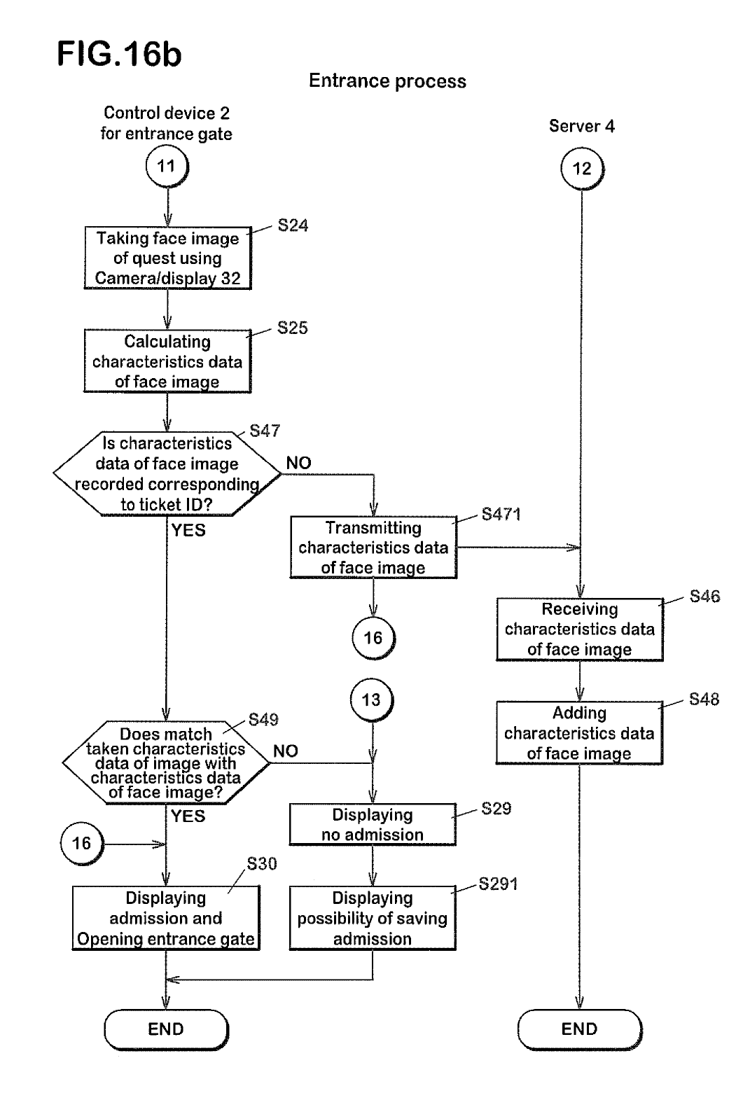

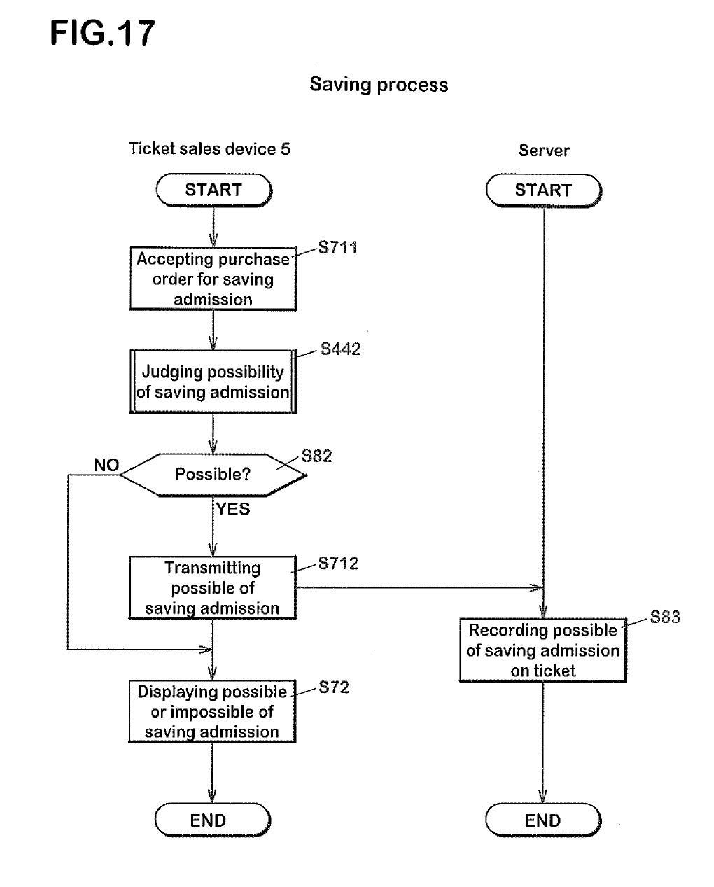

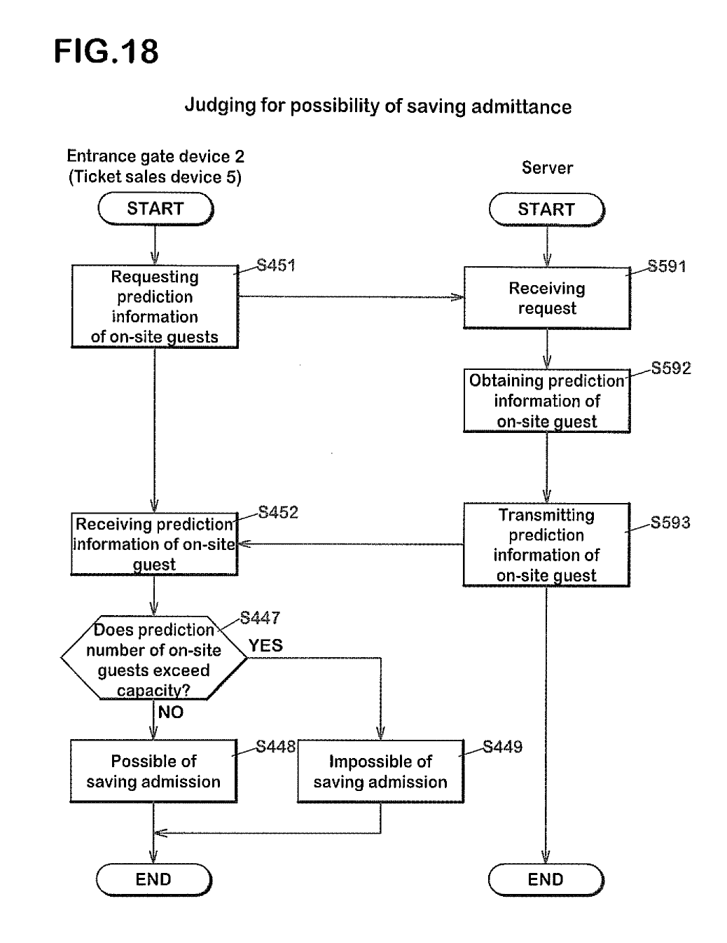

The processes by the individual means in FIG. 10b are the same as those of the means in FIG. 10a. A flow chart of an admission process by the system of FIG. 10b is shown in FIG. 16a and FIG. 16b. Further, a flow chart of a saving process is shown in FIG. 17. Further, a judging process for saving admission possibility is shown in FIG. 18.

The above examples of modifications are also applicable to the first embodiment so long as the modifications do not deviate from the scope of the invention.

1. An admission system which corresponds to a ticket permitting admission to facilities on either an odd-numbered day or an even-numbered day within a predetermined period,
comprising a control device for entrance gate disposed at an entrance to the facilities and a server communicably connected to the control device for entrance gate,
wherein the server comprises:
a recording part that records ticket information which includes a ticket ID of the ticket and admission day information indicating whether the pertinent ticket permits admission on the odd-numbered day or the even-numbered day;
judging means for admission that obtains the admission day information of the pertinent ticket based on the ticket ID transmitted from the control device for entrance gate and determines whether or not at least today is the day when the pertinent ticket permits admission; and
transmitting means that transmits a judgment result of the judging means for admission to the control device for entrance gate via a transmission part, and
the control device for entrance gate comprises:
obtaining means for ticket ID that obtains a ticket ID from a ticket possessed by a user;
transmitting means that transmits the obtained ticket ID to the server via the transmission part; and
control means that outputs “admitted/unadmitted” to a display part based on a judgment result of the judging means for admission transmitted from the server.

2. A server for an admission system corresponding to a ticket permitting admission to facilities on either an odd-numbered day or an even-numbered day within a predetermined period, comprising:
a recording part that records ticket information which includes a ticket ID of the ticket and admission day information indicating whether the ticket permits admission on the odd-numbered day or on the even-numbered day;
judging means for admission that obtains the admission day information of the pertinent ticket based on the ticket ID transmitted from a control device for entrance gate and determines whether or not at least today is the day when the pertinent ticket permits admission; and
transmitting means that transmits a judgment result of the judging means for admission to the control device for entrance gate via a transmission part.

3. The admission system according to claim 1,
further comprising a ticket sales device connected to the server,
wherein the ticket sales device comprises transmitting means that transmits application for saving admission to the server,
judging means for saving admission possibility of the server receives the application for saving admission transmitted from the ticket sales device and judges the possibility of saving admission,
the server further comprises decision means for saving admission that receives the application for saving admission and updates the ticket information recorded in the recording part with an information piece “saving admission permitted” if the judging means for saving admission possibility determines that the saving admission is possible, and
the judging means for admission of the server refers to the ticket information of the recording part and determines to permit admission if at least today is the day when the pertinent ticket permits admission or if “saving admission permitted” applies to the pertinent ticket.

4. The server according to claim 2,
wherein judging means for saving admission possibility of the server receives application for saving admission transmitted from a ticket sales device and judges the possibility of saving admission,
the server further comprises decision means for saving admission that receives the application for saving admission and updates the ticket information recorded in the recording part with an information piece “saving admission permitted” if the judging means for saving admission possibility determines that the saving admission is possible, and
the judging means for admission of the server refers to the ticket information of the recording part and determines to permit admission if at least today is the day when the pertinent ticket permits admission or if “saving admission permitted” applies to the pertinent ticket.

5. An admission system which corresponds to a ticket permitting admission to facilities on either an odd-numbered day or an even-numbered day within a predetermined period,
comprising a control device for entrance gate disposed at an entrance to the facilities and a server communicably connected to the control device for entrance gate,
wherein the server comprises:
a recording part that records ticket information which includes a ticket ID of the ticket and admission day information indicating whether the pertinent ticket permits admission on the odd-numbered day or on the even-numbered day and records prediction information of on-site guests;
judging means for admission that obtains the admission day information of the pertinent ticket based on the ticket ID transmitted from the control device for entrance gate and determines whether or not at least today is the day when the pertinent ticket permits admission;
judging means for saving admission possibility that, when the judging means for admission determines not to permit admission, determines, based on the prediction information of on-site guests recorded in the recording part, whether or not a predicted number of on-site guests for today leaves room relative to the upper limit of the on-site guests and determines that the saving admission is possible if there is some room or determines that the saving admission is impossible if there is little room; and
transmitting means that transmits judgment results of the judging means for admission and judging means for saving admission possibility to the control device for entrance gate via a transmission part, and
the control device for entrance gate comprises:
obtaining means for ticket ID that obtains a ticket ID from a ticket possessed by a user;
transmitting means that transmits the obtained ticket ID to the server; and
control means that outputs “admitted/unadmitted” to a display part based on a judgment result of the judging means for admission transmitted from the server, and that in the case of “unadmitted”, outputs “saving admission possible/impossible” to the display part based on a judgment result of the judging means for saving admission possibility.

6. A server for an admission system corresponding to a ticket permitting admission to facilities on either an odd-numbered day or an even-numbered day within a predetermined period, comprising:
a recording part that records ticket information which includes a ticket ID of the ticket and admission day information indicating whether the pertinent ticket permits admission on the odd-numbered day or on the even-numbered day and records prediction information of on-site guests;
judging means for admission that obtains the admission day information of the pertinent ticket based on the ticket ID transmitted from a control device for entrance gate and determines whether or not at least today is the day when the pertinent ticket permits admission;
judging means for saving admission possibility that, when the judging means for admission determines not to permit admission, determines, based on the prediction information of on-site guests recorded in the recording part, whether or not a predicted number of on-site guests for today leaves room relative to an upper limit of the on-site guests and determines that the saving admission is possible if there is some room or determines that the saving admission is impossible if there is little room; and
transmitting means that transmits judgment results of the judging means for admission and judging means for saving admission possibility to the control device for entrance gate via a transmission part.

7. A control device for entrance gate for an admission system corresponding to a ticket permitting admission to facilities on either an odd-numbered day or an even-numbered day within a predetermined period, comprising:
obtaining means for ticket ID that obtains a ticket ID from a ticket possessed by a user;
transmitting means that transmits the obtained ticket ID to a server; and
control means that outputs “admitted/unadmitted” to a display part based on a judgment result of judging means for admission transmitted from the server and that in the case of “unadmitted”, outputs “saving admission possible/impossible” to the display part based on a judgment result of judging means for saving admission possibility.

8. The server according to claim 6,
wherein the prediction information of on-site guests recorded in the recording part is data on the number of on-site guests predicted at predetermined time intervals, and
the judging means for saving admission possibility of the server comprises:
calculating means for actual on-site guests that calculates the present number of actual on-site guests based on the number of guests admitted by the judging means for admission and the number of exited guests detected by an exiting guest sensor;
correcting means for prediction information that corrects the prediction information of on-site guests based on the present number of actual on-site guests and the predicted number of on-site guests at a predetermined clock time corresponding to the present clock time; and
judging means for overflow that determines whether or not the corrected prediction of on-site guests will exceed the upper limit of on-site guests at any clock time from now, and determines that the saving admission is impossible if the upper limit will be exceeded or determines that the saving admission is possible if the upper limit will not be exceeded.

9. The server according to claim 6,
wherein the judging means for saving admission possibility receives inquiry about the possibility of saving admission from the ticket sales device and judges the possibility of saving admission, and
the transmitting means transmits a judgment result of the judging means for saving admission possibility in response to the inquiry about the possibility of saving admission transmitted from the ticket sales device.

10. The server according to claim 6,
wherein the judging means for saving admission possibility receives application for saving admission transmitted from the ticket sales device and judges the possibility of saving admission,
the server further comprises decision means for saving admission that receives the application for saving admission and updates the ticket information recorded in the recording part with an information piece “saving admission permitted” if the judging means for saving admission possibility determines that the saving admission is possible, and
the judging means for admission refers to the ticket information of the recording part and determines to permit admission if at least today is the day when the pertinent ticket permits admission or if “saving admission permitted” applies to the pertinent ticket.

11. The server according to claim 6,
wherein the judging means for saving admission possibility updates the ticket information recorded in the recording part with an information piece “saving admission possible” when the judging means for admission determines not to permit admission and the judging means for saving admission possibility determines that the saving admission is possible,
the server further comprises decision means for saving admission that receives application for the saving admission and updates the ticket information with an information piece “saving admission permitted” if the ticket information indicates that the saving admission is possible, and
the judging means for admission refers to the ticket information of the recording part and determines to permit admission if at least today is the day when the pertinent ticket permits admission or if “saving admission permitted” applies to the pertinent ticket.

12. An admission system which corresponds to a ticket permitting admission to facilities on a given day within a predetermined period, comprising a control device for entrance gate disposed at an entrance to the facilities and a server communicably connected to the control device for entrance gate,
wherein the server comprises:
a recording part that records ticket information which includes a ticket ID of the ticket and admission day information indicating a day when the pertinent ticket permits admission or a day when the pertinent ticket does not permit admission;
judging means for admission that obtains the admission day information of the pertinent ticket based on the ticket ID transmitted from the control device for entrance gate and determines whether or not at least today is the day when the pertinent ticket permits admission; and
transmitting means that transmits a judgment result of the judging means for admission to the control device for entrance gate via a transmission part, and
the control device for entrance gate comprises:
obtaining means for ticket ID that obtains a ticket ID from a ticket possessed by a user;
transmitting means that transmits the obtained ticket ID to the server via the transmission part; and
control means that outputs “admitted/unadmitted” to a display part based on a judgment result of the judging means for admission transmitted from the server.

13. An admission system which corresponds to a ticket permitting admission to facilities on a given day within a predetermined period, comprising a control device for entrance gate disposed at an entrance to the facilities and a server communicably connected to the control device for entrance gate,
wherein the server comprises:
a recording part that records ticket information which includes a ticket ID of the ticket and admission day information indicating a day when the pertinent ticket permits admission or a day when the pertinent ticket does not permit admission and records prediction information of on-site guests;
judging means for admission that obtains the admission day information of the pertinent ticket based on the ticket ID transmitted from the control device for entrance gate and determines whether or not at least today is the day when the pertinent ticket permits admission;
judging means for saving admission possibility that, when the judging means for admission determines not to permit admission, determines, based on the prediction information of on-site guests recorded in the recording part, whether or not a predicted number of on-site guests for today leaves room relative to an upper limit of the on-site guests and determines that the saving admission is possible if there is some room or determines that the saving admission is impossible if there is little room; and
transmitting means that transmits judgment results of the judging means for admission and the judging means for saving admission possibility to the control device for entrance gate via a transmission part, and
the control device for entrance gate comprises:
obtaining means for ticket ID that obtains a ticket ID from a ticket possessed by a user;
transmitting means that transmits the obtained ticket ID to the server via the transmission part; and
control means that outputs “admitted/unadmitted” to a display part based on a judgment result of the judging means for admission transmitted from the server and that in the case of “admission unpermitted”, outputs “saving admission possible/impossible” to the display part based on a judgment result of the judging means for saving admission possibility.

14. An admission system which corresponds to a ticket permitting admission to facilities on either an odd-numbered day or an even-numbered day within a predetermined period,
comprising a control device for entrance gate disposed at an entrance to the facilities and a server communicably connected to the control device for entrance gate,
wherein the server comprises:
a recording part that records ticket information which includes a ticket ID of the ticket and admission day information indicating whether the pertinent ticket permits admission on the odd-numbered day or on the even-numbered day;
obtaining means for ticket information that obtains ticket information corresponding to the pertinent ticket ID transmitted from the control device for entrance gate; and
transmitting means that transmits the ticket information to the control device for entrance gate via a transmission part, and
the control device for entrance gate comprises:
obtaining means for ticket ID that obtains a ticket ID from a ticket possessed by a user;
transmitting means that transmits the obtained ticket ID to the server via the transmission part;
judging means for admission that obtains the admission day information of the pertinent ticket based on the ticket information transmitted from the server and determines whether or not at least today is the day when the pertinent ticket permits admission, and
control means that outputs “admitted/unadmitted” to a display part based on a judgment result of the judging means for admission.

15. A control device for entrance gate for an admission system corresponding to a ticket permitting admission to facilities on either an odd-numbered day or an even-numbered day within a predetermined period, comprising:
obtaining means for ticket ID that obtains a ticket ID from a ticket possessed by a user;
transmitting means that transmits the obtained ticket ID to a server via the transmission part;
judging means for admission that obtains the admission day information of the pertinent ticket based on the ticket information transmitted from the server and determines whether or not at least today is the day when the pertinent ticket permits admission; and
control means that outputs “admitted/unadmitted” to a display part based on a judgment result of the judging means for admission.

16. The admission system according to claim 14,
further comprising a ticket sales device connected to the server,
wherein the ticket sales device comprises transmitting means that transmits decision on saving admission to the server,
the server further comprises decision means for saving admission that receives the decision on saving admission and updates the ticket information recorded in the recording part with an information piece “saving admission permitted”, and
the judging means for admission of the control device for entrance gate refers to the ticket information and determines to permit admission if at least today is the day when the pertinent ticket permits admission or if “saving admission permitted” applies to the pertinent ticket.

17. The admission system according to claim 16,
wherein the ticket sales device comprises transmitting means that transmits application for saving admission to the server,
the server comprises obtaining means for fundamental information that receives the pertinent application for saving admission and obtains fundamental information including at least prediction information of on-site guests,
the transmitting means of the server transmits the pertinent fundamental information to the ticket sales device, and
the ticket sales device comprises judging means for saving admission possibility that judges the possibility of saving admission based on the fundamental information and transmits decision on the saving admission to the server if the judging means determines that the saving admission is possible.

18. An admission system which corresponds to a ticket permitting admission to facilities on either an odd-numbered day or an even-numbered day within a predetermined period,
comprising a control device for entrance gate disposed at an entrance to the facilities and a server communicably connected to the control device for entrance gate,
wherein the server comprises:
a recording part that records ticket information which includes a ticket ID of the ticket and admission day information indicating whether the pertinent ticket permits admission on the odd-numbered day or on the even-numbered day and records prediction information of on-site guests;
obtaining means for ticket information that obtains ticket information corresponding to the pertinent ticket ID transmitted from the control device for entrance gate;
obtaining means for fundamental information that receives request for fundamental information transmitted from the control device for entrance gate and obtains fundamental information including at least prediction information of on-site guests; and
transmitting means that transmits the ticket information and the fundamental information to the control device for entrance gate via a transmission part, and
the control device for entrance gate comprises:
obtaining means for ticket ID that obtains a ticket ID from a ticket possessed by a user;
transmitting means that transmits the obtained ticket ID to the server via the transmission part;
judging means for admission that obtains the admission day information of the pertinent ticket based on the ticket information transmitted from the server, determines whether or not at least today is the day when the pertinent ticket permits admission, and transmits to the server request for fundamental information used for judgment of the possibility of saving admission when determining not to permit admission;
judging means for saving admission possibility that determines, based on the fundamental information transmitted from the server, whether or not a predicted number of on-site guests for today leaves room relative to an upper limit of the on-site guests and determines that the saving admission is possible if there is some room or determines that the saving admission is impossible if there is little room; and
control means that outputs “admitted/unadmitted” to a display part based on a judgment result of the judging means for admission, and that in the case of “admission unpermitted”, outputs “saving admission possible/impossible” to the display part based on a judgment result of the judging means for saving admission possibility.

19. A control device for entrance gate for an admission system corresponding to a ticket permitting admission to facilities on either an odd-numbered day or an even-numbered day within a predetermined period, comprising:
obtaining means for ticket ID that obtains a ticket ID from a ticket possessed by a user;
transmitting means that transmits the obtained ticket ID to the server via a transmission part;
judging means for admission that obtains admission day information of the pertinent ticket based on ticket information transmitted from the server, determines whether or not at least today is the day when the pertinent ticket permits admission, and transmits to the server request for fundamental information used for judgment of the possibility of saving admission when determining not to permit admission;
judging means for saving admission possibility that determines, based on the fundamental information transmitted from the server, whether or not a predicted number of on-site guests for today leaves room relative to an upper limit of the on-site guests and determines that the saving admission is possible if there is some room or determines that the saving admission is impossible if there is little room; and
control means that outputs “admitted/unadmitted” to a display part based on a judgment result of the judging means for admission, and that in the case of “admission unpermitted”, outputs “saving admission possible/impossible” to the display part based on a judgment result of the judging means for saving admission possibility.

20. The admission system according to claim 18,
wherein the prediction information of on-site guests recorded in the recording part is data on the number of on-site guests predicted at predetermined time intervals,
the server comprises:
calculating means for actual on-site guests that calculates the present number of actual on-site guests based on the number of guests admitted by the judging means for admission and the number of exited guests detected by an exiting guest sensor and records the present number of actual on-site guests in the recording part; and
correcting means for prediction information that corrects the prediction information of on-site guests based on the present number of actual on-site guests and the predicted number of on-site guests at a predetermined clock time corresponding to the present clock time and records the corrected prediction information in the recording part; and
the judging means for saving admission possibility of the control device for entrance gate comprises judging means for overflow that determines whether or not the predicted number of on-site guests will exceed the upper limit of on-site guests at any clock time from now, and determines that the saving admission is impossible if the upper limit will be exceeded or determines that the saving admission is possible if the upper limit will not be exceeded.

21. The admission system according to claim 18, further comprising a ticket sales device connected to the server,
wherein the ticket sales device comprises transmitting means that transmits decision on saving admission to the server,
the server further comprises decision means for saving admission that receives the decision on saving admission and updates the ticket information recorded in the recording part with an information piece “saving admission permitted”, and
the judging means for admission of the control device for entrance gate refers to the ticket information and determines to permit admission if at least today is the day when the pertinent ticket permits admission or if “saving admission permitted” applies to the pertinent ticket.

22. The admission system according to claim 21,
wherein the ticket sales device comprises transmitting means that transmits application for saving admission to the server,
the server comprises obtaining means for fundamental information that receives the pertinent application for fundamental information and obtains fundamental information including at least prediction information of on-site guests,
the transmitting means of the server transmits the pertinent fundamental information to the ticket sales device, and
the ticket sales device comprises judging means for saving admission possibility that judges the possibility of saving admission based on the fundamental information and transmits decision on saving admission to the server when determining that the saving admission is possible.

23. An admission system which corresponds to a ticket permitting admission to facilities on a given day within a predetermined period,
comprising a control device for entrance gate disposed at an entrance to the facilities and a server communicably connected to the control device for entrance gate,
wherein the server comprises:
a recording part that records ticket information which includes a ticket ID of the ticket and admission day information indicating a day when the pertinent ticket permits admission or a day when the pertinent ticket does not permit admission;
obtaining means for ticket information that obtains ticket information corresponding to the pertinent ticket ID transmitted from the control device for entrance gate; and
transmitting means that transmits the ticket information to the control device for entrance gate via a transmission part, and
the control device for entrance gate comprises:
obtaining means for ticket ID that obtains a ticket ID from a ticket possessed by a user;
transmitting means that transmits the obtained ticket ID to the server via the transmission part;
judging means for admission that obtains admission day information of the pertinent ticket based on the ticket information transmitted from the server and determines whether or not at least today is the day when the pertinent ticket permits admission; and
control means that outputs “admitted/unadmitted” to a display part based on a judgment result of the judging means for admission.

24. An admission system which corresponds to a ticket permitting admission to facilities on a given day within a predetermined period,
comprising a control device for entrance gate disposed at an entrance to the facilities and a server communicably connected to the control device for entrance gate,
wherein the server comprises:
a recording part that records ticket information which includes a ticket ID of the ticket and admission day information indicating a day when the pertinent ticket permits admission or a day when the pertinent ticket does not permit admission and records prediction information of on-site guests;
obtaining means for ticket information that obtains ticket information corresponding to the pertinent ticket ID transmitted from the control device for entrance gate;
obtaining means for fundamental information that receives request for fundamental information transmitted from the control device for entrance gate and obtains fundamental information including at least the prediction information of on-site guests, and
transmitting means that transmits the ticket information and the fundamental information to the control device for entrance gate via a transmission part, and
the control device for entrance gate comprises:
obtaining means for ticket ID that obtains a ticket ID from a ticket possessed by a user;
transmitting means that transmits the obtained ticket ID to the server via the transmission part;
judging means for admission that obtains admission day information of the pertinent ticket based on the ticket information transmitted from the server, determines whether or not at least today is the day when the pertinent ticket permits admission, and transmits to the server request for fundamental information used for judgment of the possibility of saving admission when determining not to permit admission;
judging means for saving admission possibility that determines, based on the fundamental information transmitted from the server, whether or not the predicted number of on-site guests for today leaves room relative to an upper limit of the on-site guests and determines that the saving admission is possible if there is some room or determines that the saving admission is impossible if there is little room; and
control means that outputs “admitted/unadmitted” to a display part based on a judgment result of the judging means for admission, and that in the case of “admission unpermitted”, outputs “saving admission possible/impossible” to the display part based on a judgment result of the judging means for saving admission possibility.

25. The system or device according to claim 1, wherein out of the odd-numbered or even-numbered admission days within the predetermined period, a given day is defined as an exceptional day when the admission is unpermitted.
